(19) United States
(12) Patent Application Publication
(10) Pub. No.: US 2012/0172057 A1
(43) Pub. Date: Jul. 5, 2012

(54) ROADSIDE PORTION TRAFFIC AMOUNT CALCULATION DEVICE AND ROADSIDE PORTION TRAFFIC AMOUNT CALCULATION METHOD

(75) Inventors: Motonari Kobayashi, Chiyoda-ku (JP); Ichiro Okajima, Chiyoda-ku (JP); Tomohiro Nagata, Chiyoda-ku (JP); Atsushi Murase, Yokosuka-shi (JP)

(73) Assignee: NTT DOCOMO, INC., Tokyo (JP)

(21) Appl. No.: 13/394,587

(22) PCT Filed: Aug. 10, 2010
(86) PCT No.: PCT/JP2010/063564

§ 371 Date: Mar. 7, 2012

(30) Foreign Application Priority Data
Sep. 18, 2009 (JP) 2009-217582

(51) Int. Cl. H04W 24/00

(52) U.S. Cl. 455/456.1

(57) ABSTRACT

A roadside portion traffic amount calculation device includes an acquisition unit that acquires positional information, a distribution determination unit that refers to road information stored in a road information storage unit and, based on a positional relationship between locations of users indicated by the positional information and a road, determines a passage roadside portion that is a roadside portion in which the locations of the users are distributed for each piece of the positional information, a summarizing unit that counts the number of pieces of the positional information for which the passage roadside portion has been determined by the distribution determination unit for each of the roadside portions and summarizes a roadside portion traffic amount that is an amount of user traffic on each of the roadside portions, and a processing result output unit that outputs the roadside portion traffic amount summarized by the summarizing unit.

### TECHNICAL FIELD

The present invention relates to a roadside portion traffic amount calculation device and a roadside portion traffic amount calculation method.

### BACKGROUND ART

In mobile terminals or the like, when using an application service that uses positional information such as route guidance service, positional information measured by a GPS device that a mobile terminal has, positional information indicating the location of a base station, and the like are used as information that indicates the location of the mobile terminal. Although collected positional information contains errors arising from an acquisition method for each location, by a technique such as map matching, it is possible to determine the road where the mobile terminal exists. Patent Literature 1, for example, describes a technique to correct positional information acquired by GPS devices or the like by a map matching process.

### CITATION LIST

### Patent Literature

[Patent Literature 1] Japanese Patent Application Laid-Open Publication No. 2005-233779

### SUMMARY OF INVENTION

### Technical Problem

When mobile terminals use an application service that uses positional information as described above, server devices or the like that provide the application service can collect positional information of the mobile terminals. Because locations of the mobile terminals are found by the positional information thus collected, in a predetermined section of a certain road, it is possible to obtain the amount of traffic of users who have the mobile terminals.

On the other hand, sidewalks are provided to both roadside portions of roads that have a certain width or more, and pedestrians walk on either of the sidewalks. Even on the road that is not provided with a sidewalk, it is often the case that pedestrians walk along either of roadside portions. With a technique to obtain the amount of traffic on a road from the positional information of the above-mentioned mobile terminals, it is possible to obtain the amount of traffic on the whole road. However, the amount of traffic on each sidewalk or roadside portion cannot be determined. On the other hand, in the case of planning to open a shop in a place along a road, for example, there is a demand to know the amount of traffic of pedestrians on each roadside portion.

In view of such problems, it is an object of the present invention to provide a roadside portion traffic amount calculation device and a roadside portion traffic amount calculation method that can obtain the amount of traffic of pedestrians on each roadside portion of a road.

### Solution to Problem

To solve the problem described above, a roadside portion traffic amount calculation device of the present invention is a device that, based on positional information indicating locations of users, calculates the number of users moving on each roadside portion of a road. The roadside portion traffic amount calculation device includes positional information acquisition means for acquiring one or more pieces of the positional information; positional information distribution determination means for referring to road information that is information regarding the road and, based on a positional relationship between the locations of the users indicated by the positional information and the road, determining a passage roadside portion that is a roadside portion in which the locations of the users are distributed for each piece of the positional information; positional information summarizing means for counting the number of pieces of the positional information for which the passage roadside portion has been determined by the positional information distribution determination means for each of the roadside portions, and summarizing a roadside portion traffic amount that is an amount of user traffic on each of the roadside portions; and processing result output means for outputting the roadside portion traffic amount summarized by the positional information summarizing means.

In addition, to solve the problem described above, a roadside portion traffic amount calculation method of the present invention is a method for, based on positional information indicating locations of users of mobile terminals, calculating the number of users moving on each roadside portion of a road. The roadside portion traffic amount calculation method includes a positional information acquisition step of acquiring one or more pieces of the positional information; a positional information distribution determination step of referring to road information that is information regarding the road and, based on a positional relationship between the locations of the users indicated by the positional information and the road, determining a passage roadside portion that is a roadside portion in which the locations of the users are distributed for each piece of the positional information; a positional information summarizing step of counting the number of pieces of the positional information for which the passage roadside portion has been determined at the positional information distribution determination step for each of the roadside portions and summarizing a roadside portion traffic amount that is an amount of user traffic on each of the roadside portions; and a processing result output step of outputting the roadside portion traffic amount summarized at the positional information summarizing step.

With the roadside portion traffic amount calculation device and the roadside portion traffic amount calculation method of the present invention, the passage roadside portions of users are determined based on the positional relationship between the locations of the users indicated by the positional information of the mobile terminals and the road, and the roadside portion traffic amount is summarized by counting the number of pieces of the positional information for which the passage roadside portion has been determined for each of the roadside portions. Accordingly, it is possible to obtain the amount of pedestrian traffic on each of the roadside portions of the road. It should be noted that the roadside portions are areas that lie on both ends in the width direction of the road. In addition, the mobile terminal is a terminal device that is movable together with a user, it is not limited to a cellular phone, and what is called a portable personal computer, a car navigation device, and other devices are also included therein.

In addition, the roadside portion traffic amount calculation device of the present invention includes map matching processing means; the road information includes information regarding location of the road; the map matching processing means, based on the information regarding the location of the road included in the road information, performs a map matching process on the positional information acquired by the positional information acquisition means, and extracts the positional information that is associated with a road the roadside portion traffic amount of which is to be summarized; and the positional information distribution determination means determines the passage roadside portion of the positional information extracted by positional information extracting means.

In this case, because determination of the passage roadside portion is performed with respect to the positional information extracted by the map matching process, the determination process is performed only with respect to the positional information of users who may exist with high probability on the road for which the traffic amount is to be summarized. Therefore, the accuracy of summarizing the roadside portion traffic amount improves.

In addition, the roadside portion traffic amount calculation device of the present invention includes positional information extracting means; the positional information includes traffic mode information that is information to determine whether the users whose locations are indicated by the positional information are walking or riding on vehicles; the positional information extracting means refers to the traffic mode information of the positional information acquired by the positional information acquisition means, and extracts the positional information of the users who are walking; and the positional information distribution determination means determines the passage roadside portions of the positional information extracted by the positional information extracting means.

In this case, because the positional information determined to be positional information of pedestrians are extracted and determination regarding the passage roadside portion is performed only with respect to the positional information thus extracted, determination regarding the passage roadside portion is not performed with respect to the positional information of users who are riding on vehicles. Therefore, the accuracy of summarizing the roadside portion traffic amount improves.

In addition, in the roadside portion traffic amount calculation device of the present invention, the positional information distribution determination means determines a roadside portion that is closer to the location of the user out of both roadside portions to be the passage roadside portion regarding the positional information.

In this case, it is possible to appropriately determine the roadside portion where users may exist with high probability on the basis of the positional information.

In addition, in the roadside portion traffic amount calculation device of the present invention, the positional information includes error information regarding the locations of the users; the road information includes information regarding an area of a sidewalk that lies at each of the roadside portions of the road; the positional information distribution determination means, based on the locations of the positional information and the error information, generates probability density distribution regarding the locations of the users; and the positional information summarizing means, out of a plurality of probability density distributions generated by the positional information distribution determination means, adds up the probability density distributed in the area of the sidewalk of the road for each roadside portion to summarize the roadside portion traffic amount.

In this case, the locations of the users are expressed as the probability density distribution on the basis of the error information included in the positional information, whereby the locations of the users are expressed more accurately. In addition, based on the probability density distribution generated, the roadside portion traffic amount is summarized by adding up probability density distributed in the area of the sidewalk of the road for each of the roadside portions, whereby the accuracy of the roadside portion traffic amount improves.

In addition, in the roadside portion traffic amount calculation device of the present invention, the positional information includes, together with the information indicating the locations of the users of the mobile terminals, date and time information that is information on date and time when the users exist in the locations; the positional information distribution determination means extracts past positional information that is positional information, in a period before being specified by the date and time information included in summarizing target positional information that is positional information for which the roadside portion traffic amount is to be summarized, indicating locations of users of the summarizing target positional information for each piece of the summarizing target positional information, determines the roadside portion where the locations of the users indicated in the past positional information extracted are distributed with respect to all of the past positional information corresponding to the summarizing target positional information, counts the number of pieces of the past positional information for which distribution of the locations has been determined for each of the roadside portions, and determines the roadside portion where the number of the pieces of the past positional information counted is larger to be the passage roadside portion regarding the summarizing target positional information; and the positional information summarizing means counts the number of pieces of the summarizing target positional information of which the passage roadside portion is determined by the positional information distribution determination means for each of the roadside portions, and summarizes a roadside portion traffic amount that is an amount of user traffic for each of the roadside portions.

In this case, the past positional information is extracted for each piece of the summarizing target positional information, distribution of the past positional information is determined for each of the roadside portions, and the roadside portion of which the number of pieces of the past positional information is larger is determined to be the passage roadside portion regarding the summarizing target positional information. Accordingly, based on the tendency of user passage on the roadside portions in the past, distribution for either of the roadside portions of the summarizing target positional information is determined. Therefore, the accuracy of the roadside portion traffic amount improves.

In addition, in the roadside portion traffic amount calculation device of the present invention, the positional information acquisition means acquires the past positional information in which, within a predetermined time frame including time indicated in the date and time information of the summarizing target positional information, the time indicated in the date and time information falls.

In this case, when determining distribution for each of the roadside portion of the summarizing target positional information on the basis of the past positional information, it is possible to perform determination more appropriately considering the tendency of user passage on the roadside portions in the past. Therefore, it is possible to further improve the accuracy of the roadside portion traffic amount.

In addition, the roadside portion traffic amount calculation device of the present invention further includes dividing line calculation means for, out of positional information acquired by the positional information acquisition means, extracting the positional information indicating that the users are riding on vehicles and, based on the moving direction of the users whose locations are indicated by the positional information extracted, and calculating a dividing line that divides the road into areas in each of which vehicles traveling in the same direction are distributed and that contain the respective roadside portions; and the positional information distribution determination means, by determining in which area divided by the dividing line pieces of the positional information of the users who are walking extracted by the positional information extracting means are distributed, determines the passage roadside portions of users whose locations are indicated by the positional information.

In a general road, the moving directions of vehicles are divided by a line that is set near the center part in the width direction of the road, for example. In the roadside portion traffic amount calculation device of the present invention, based on the moving direction of positional information of vehicles, the road is divided by a dividing line into two areas that contain the respective roadside portions at both ends of the road. This makes it possible to recognize the boundary between both roadside portions of the road. In addition, by determining in which area divided by the dividing line pieces of positional information of pedestrians are distributed, it is possible to determine the passage roadside portions of the pedestrians. Furthermore, because the dividing line is calculated based on the moving direction of positional information of vehicles the positions of which are measured by the same method as that of positional information of pedestrians to be summarized, when determining the passage roadside portion of the positional information of the pedestrians, it is possible to cancel errors in measurement of the positions of the positional information of the pedestrians.

In addition, in the roadside portion traffic amount calculation device of the present invention, the positional information includes error information regarding the locations of the users; the positional information distribution determination means, based on the locations of the positional information and the error information, generates probability density distribution regarding the locations of the users; and the positional information summarizing means, out of a plurality of probability density distributions generated by the positional information distribution determination means, adds up the probability density distributed in each of the areas divided by the dividing line in the road to summarize the roadside portion traffic amount.

In this case, the locations of the users are expressed as the probability density distribution on the basis of the error information included in the positional information, whereby the locations of the users are expressed more accurately. In addition, based on the probability density distribution generated, the roadside portion traffic amount is summarized by adding up probability density distributed in each of the areas divided by the dividing line for each of the areas, whereby the accuracy of the roadside portion traffic amount improves.

In addition, the roadside portion traffic amount calculation device of the present invention, the roadside portion dividing line calculation means, based on transition of positional information of the same user that is continuous on a time-series basis, can determine the moving direction of users whose locations are indicated by the positional information. Accordingly, it is possible to appropriately determine the moving direction of the positional information of vehicles.

### Advantageous Effects of Invention

With the roadside portion traffic amount calculation device and the roadside portion traffic amount calculation method according to the present invention, based on positional information of users of mobile terminals, it is possible to obtain the amount of traffic of pedestrians on each roadside portion of a road.

### BRIEF DESCRIPTION OF DRAWINGS

FIG. 1 is a block diagram illustrating a functional structure of a roadside portion traffic amount calculation device.

FIG. 2 is a diagram illustrating one example of a structure and contents of positional information.

FIG. 3 is a hardware block diagram of the roadside portion traffic amount calculation device.

FIG. 4 is a diagram illustrating one example of a structure and contents of road information.

FIG. 5 is a diagram schematically illustrating a structure of a road depicted by road information.

FIG. 6 is a flowchart illustrating processes of a roadside portion traffic amount calculation method that is implemented in the roadside portion traffic amount calculation device.

FIG. 7 includes flowcharts illustrating processes of a positional information distribution determination process and a positional information summarization process.

FIG. 8 includes diagrams illustrating an example of positional information to explain a process for individualizing positional information by user ID.

FIG. 9 includes a diagram schematically illustrating a road depicted based on road information and locations indicated by each piece of positional information and a diagram illustrating a state in which the positional information is associated with a road to be summarized by a map matching process.

FIG. 10 is a diagram illustrating one example of positional information associated with road IDs.

FIG. 11 includes diagrams schematically explaining the positional information distribution determination process.

FIG. 12 is a block diagram illustrating a functional structure of a roadside portion traffic amount calculation device according to a second embodiment.

FIG. 13 is a flowchart illustrating processes performed by the roadside portion traffic amount calculation device according to the second embodiment.

FIG. 14 includes diagrams illustrating an example of a structure and contents of positional information in the course of a roadside portion traffic amount calculation process according to the second embodiment.

FIG. 15 includes flowcharts illustrating processes of a positional information distribution determination process and a positional information summarization process according to a third embodiment.

FIG. 16 is a diagram schematically illustrating a state in which probability density distribution is generated based on positional information contained within a measuring range.

FIG. 17 is a diagram illustrating one example of positional information acquired by a positional information acquisition unit according to the third embodiment.

FIG. 18 includes flowcharts illustrating processes of a positional information distribution determination process and a positional information summarization process according to a fourth embodiment.

FIG. 19 is a diagram illustrating one piece of positional information to be summarized and the past positional information of the same user as the one piece of positional information in the fourth embodiment.

FIG. 20 is a block diagram illustrating a functional structure of a roadside portion traffic amount calculation device according to a fifth embodiment.

FIG. 21 illustrates examples of positional information acquired by a positional information acquisition unit, positional information extracted by a dividing line calculation unit, and positional information extracted by a positional information extracting unit.

FIG. 22 is a diagram illustrating an example of determination of moving direction of positional information.

FIG. 23 includes diagrams illustrating examples of positional information whose moving directions have been determined and positional information for which roadside portions where users are moving have been determined.

FIG. 24 is a diagram illustrating an example of a dividing line calculated by the dividing line calculation unit.

FIG. 25 is a flowchart illustrating processes performed in the roadside portion traffic calculation device.

FIG. 26 includes flowcharts illustrating processes at steps S62 and S62 in the flowchart of FIG. 25.

FIG. 27 is a diagram illustrating an example of pieces of positional information for which passage roadside portions have been determined.

FIG. 28 includes flowcharts illustrating processes at steps S62 and S62 in the flowchart of FIG. 25.

FIG. 29 is a diagram illustrating an example of probability density distribution generated for a piece of positional information.

### DESCRIPTION OF EMBODIMENTS

Embodiments of a roadside portion traffic amount calculation device according to the present invention will be described with reference to the drawings. It should be noted that, when appropriate, like reference signs are given to like parts, and redundant explanations are omitted.

### First Embodiment

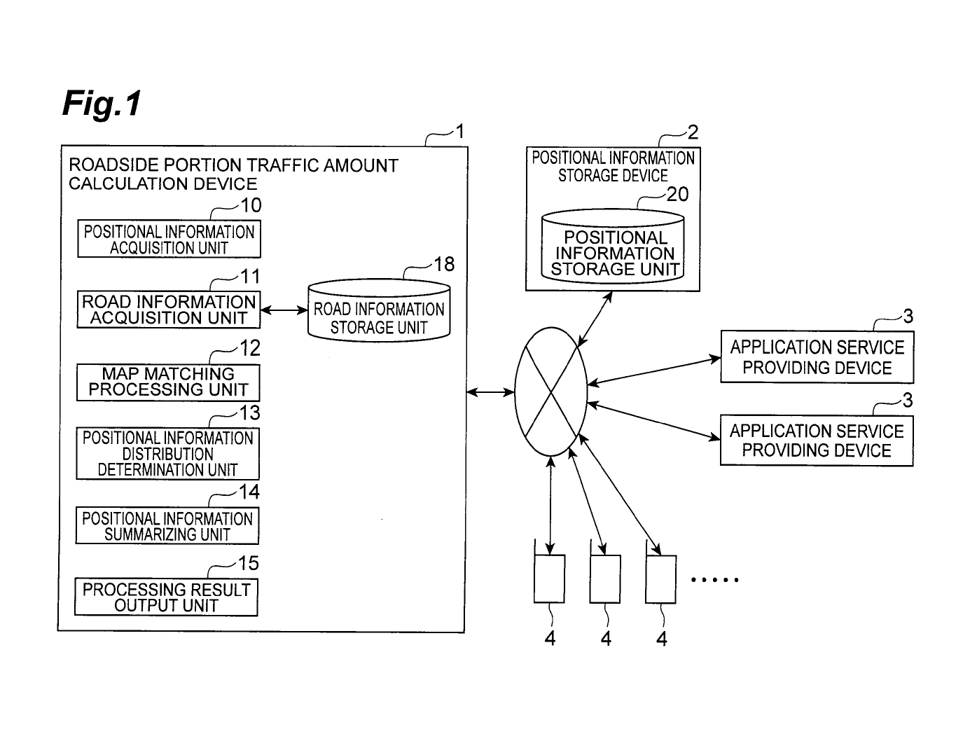

FIG. 1 is a block diagram illustrating a functional structure of a roadside portion traffic amount calculation device according to a first embodiment, and is a diagram of a whole structure of a system including the roadside portion traffic amount calculation device. As illustrated in FIG. 1, this roadside portion traffic amount calculation device 1 can communicate with a positional information storage device 2 via a network. Application service providing devices 3 and mobile terminals 4 can also communicate via the network.

Prior to an explanation of the roadside portion traffic amount calculation device 1, the positional information storage device 2 and the application service providing device 3 will now be described.

The positional information storage device 2 is a device that acquires positional information of the mobile devices from the application service providing device 3 and stores therein the positional information thus acquired. The positional information storage device 2 includes a positional information storage unit 20 for storing the positional information.

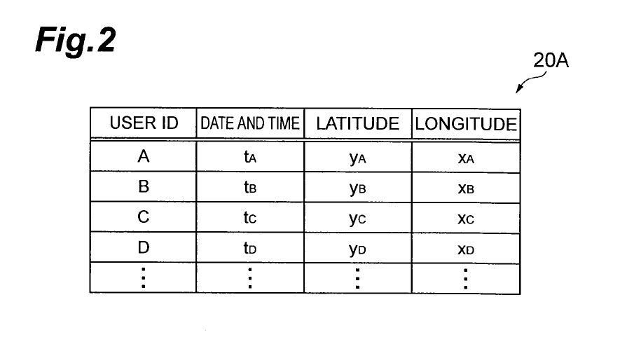

The positional information storage unit 20 is storage means for storing therein the positional information indicating the locations of the mobile terminals. FIG. 2 is a diagram illustrating one example of a structure and contents of the positional information stored in the positional information storage unit 20. As illustrated in FIG. 2, the positional information 20A includes information on date and time, latitude, and longitude in association with user IDs being information that identifies mobile terminals. With user ID “A”, for example, pieces of information of date and time “t_{A}”, latitude “y_{A}”, and longitude “x_{A}” are associated. The information of the date and time is information that indicates the date and time when this positional information is measured. The information of the latitude and the longitude is information that indicates the location of the mobile terminal of this user.

The application service providing device 3 is a device that provides the mobile terminals 4 with an application service such as a route guidance service, and is constituted by server devices, for example. When the mobile terminals 4 use an application service such as a route guidance service, positional information measured by GPS devices that the mobile terminals 4 have, positional information indicating the locations of base stations, and the like are used as information that indicates locations of the mobile terminals 4. The application service providing device 3, when the mobile terminals 4 use such an application service using positional information as described above, can collect positional information of the mobile terminals 4. Because positional information collected in the present embodiment is measured and acquired when using an application, the timing when it is acquired is aperiodic, and it is not acquired when the application is not used. It should be noted that, as positional information, the present embodiment exemplifies those collected irregularly when the mobile terminals 4 use the application, but it is not limited to such positional information. For example, it is acceptable to adopt positional information that is regularly acquired and collected as positional information of the present invention.

Referring back to FIG. 1, the roadside portion traffic amount calculation device 1 will be described. The roadside portion traffic amount calculation device 1 is a device that, based on positional information indicating the locations of the users of the mobile terminals, calculates the number of the users passing through each roadside portion of a road, and functionally includes a positional information acquisition unit 10 (positional information acquisition means), a road information acquisition unit 11, a map matching processing unit 12 (map matching processing means), a positional information distribution determination unit 13 (positional information distribution determining means), a positional information summarizing unit 14 (positional information summarizing means), a process result output unit 15 (process result output means), and a road information storage unit 18.

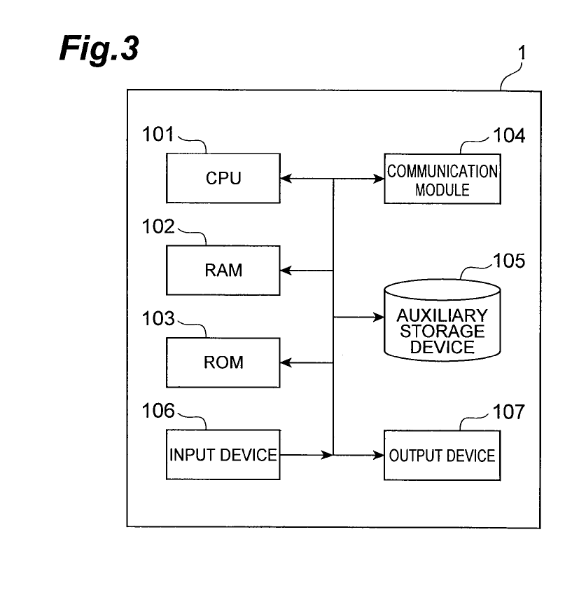

FIG. 3 is a hardware block diagram of the roadside portion traffic amount calculation device 1. The roadside portion traffic amount calculation device 1 is, as depicted in FIG. 3, physically configured as a computer system that includes a CPU 101, a RAM 102 and a ROM 103 that are main storage devices, a communication module 104 that is a data transmitting and receiving device such as a network card, an auxiliary storage device 105 such as a hard disk and a flash memory, an input device 106 such as a keyboard and a mouse being an input device, and an output device 107 such as a display. Predetermined computer software is read into hardware such as the CPU 101 and the RAM 102 illustrated in FIG. 3 to make the communication module 104, the input device 106, and the output device 107 work under the control of the CPU 101 and also to read and write data from and to the RAM 102 or the auxiliary storage device 105, whereby each function depicted in FIG. 1 is implemented. Referring back to FIG. 1, each functional unit of the roadside portion traffic amount calculation device 1 will be described in detail.

The positional information acquisition unit 10 is a unit that acquires positional information stored in the positional information storage unit 20 of the positional information storage device 2.

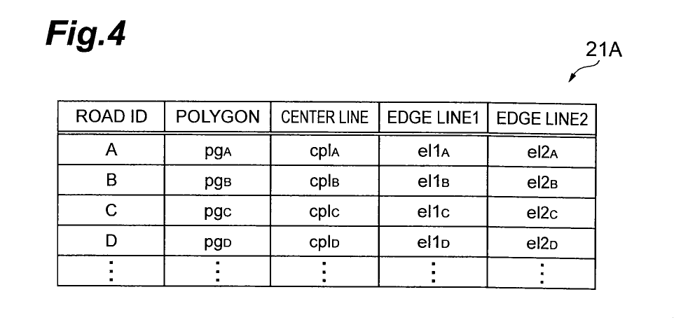

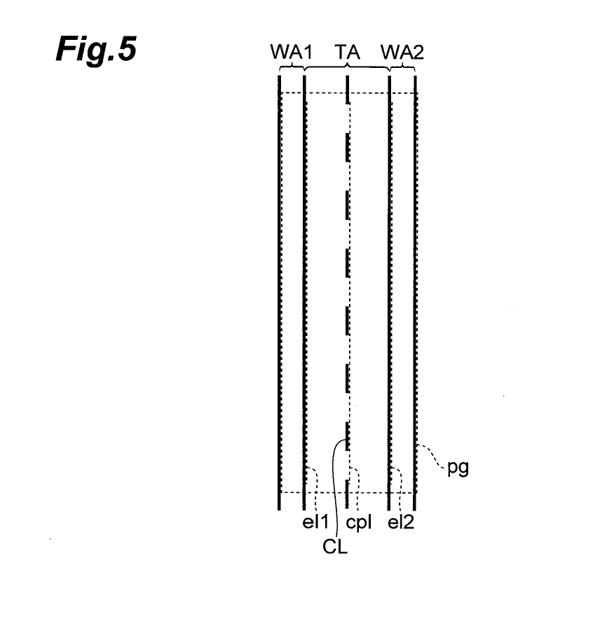

The road information acquisition unit 11 is a unit that acquires road information from the road information storage unit 18. The road information storage unit 18 will now be also described. The road information storage unit 18 is storage means storing therein road information that is information on the location and configuration of each road. The road information is stored in the road information storage unit 18 in advance. FIG. 4 is a diagram illustrating one example of a structure and contents of the positional information stored in the road information storage unit 18. FIG. 5 is a diagram schematically illustrating a road that is depicted by the road information illustrated in FIG. 4. It should be noted that, in the present embodiment, the road information storage unit 18 is structured in the roadside portion traffic amount calculation device 1, but it may be structured in a device that can communicate with the roadside portion traffic amount calculation device 1 via a network.

As depicted in FIG. 4, road information 21A includes information on a polygon pg, a center line cpl, an edge line 1 (el1), and an edge line 2 (el2) in association with road IDs. With road ID “A”, for example, pieces of information of polygon “pg_{A}”, center line “cpl_{A}”, edge line 1 “el1_{A}”, and edge line 2 “el2_{A}” are associated. The road ID, when dividing a road where the traffic amount is to be calculated into predetermined sections, is information that identifies each of the sections divided.

As depicted in FIG. 5, the polygon pg is two-dimensional polygon data that indicates the position and outline of a road within a predetermined range specified by a road ID. In addition, the center line cpl is one-dimensional line data that indicates the position of the center line CL of the road. Furthermore, the edge line 1 el1 and the edge line 2 el2 are one-dimensional line data that indicates the positions of boundaries between the driveway TA and the sidewalks WA1 and WA2. It should be noted that, in FIG. 5, broken lines indicating the polygon pg, the center line cpl, the edge line 1 el1, and the edge line 2 el2 are written in a shifted manner against lines representing each portion of the road for illustrative purposes, but they actually overlap.

The map matching processing unit 12 is a unit that performs what is called a map matching process on positional information acquired by the positional information acquisition unit 10 to associate each piece of the positional information with roads and extracts the positional information associated with a road where a roadside portion traffic amount is to be summarized. On the positional information extracted by the map matching processing unit 12, determination of roadside portions by the positional information distribution determination unit 13 is performed, and accordingly the determination process is performed only on positional information of users who may exist with high probability on the road where a traffic amount is to be summarized. It should be noted that the map matching process is a process that, by correcting positional information including errors, associates positional information that may exist with high probability on a certain road with the road to identify the road to which the positional information belongs, and thus is a well-known technique.

The positional information distribution determination unit 13 is a unit that refers to road information and, based on the positional relationship between the locations of the users indicated by the positional information and the road, determines a passage roadside portion that is a roadside portion where the locations of the users are distributed with respect to each piece of the positional information. The positional information for which the passage roadside portions are determined herein is positional information that is extracted by the map matching processing unit 12. In the present embodiment, more specifically, the positional information distribution determination unit 13 determines one of both roadside portions which is closer to the location of the user as the passage roadside portion regarding the positional information.

The positional information summarizing unit 14 is a unit that counts the number of pieces of the positional information for which the passage roadside portions have been determined by the positional information distribution determination unit 13 for each roadside portion within the measuring range of the road to be summarized, and summarizes the roadside portion traffic amount that is the amount of user traffic for each roadside portion.

The processing result output unit 15 is a unit that outputs the roadside portion traffic amount summarized by the positional information summarizing unit 14.

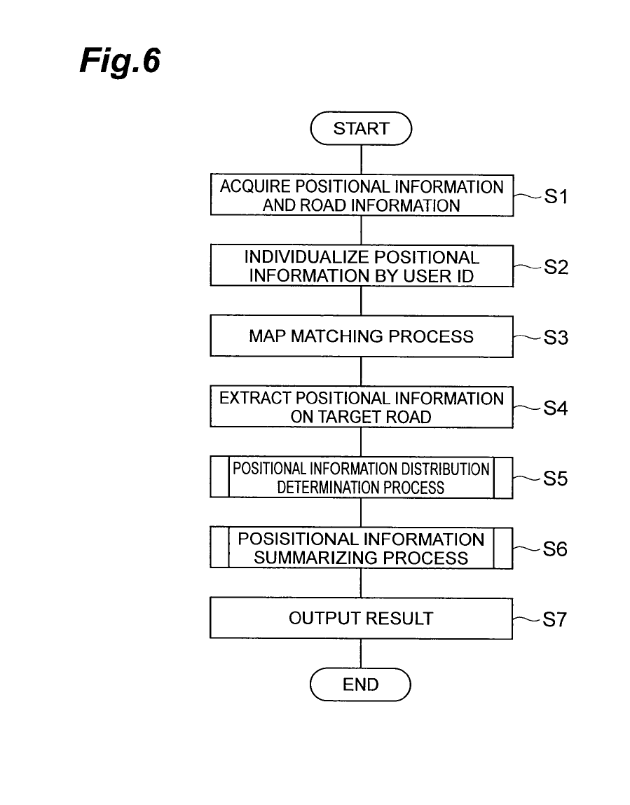

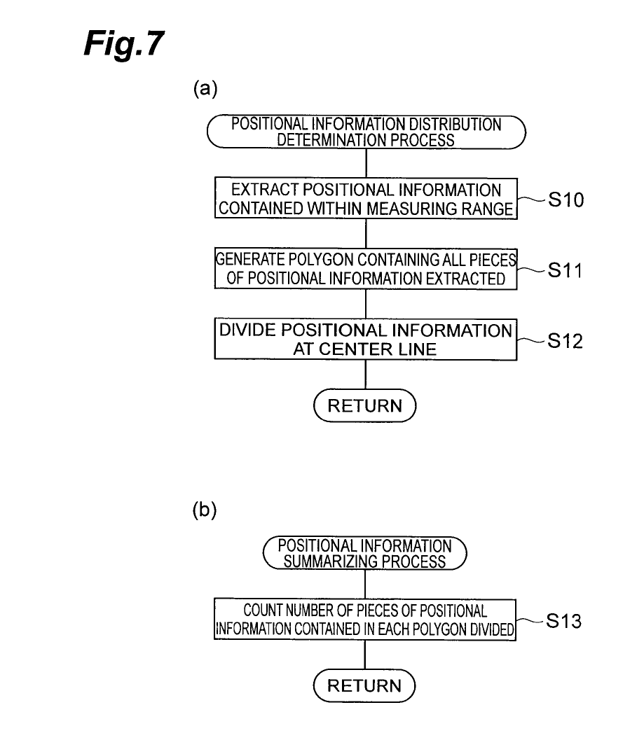

Subsequently, referring to FIG. 6 and FIG. 7, the operation of the roadside portion traffic amount calculation device 1 in the roadside portion traffic amount calculation method according to the present embodiment will be described. FIG. 6 is a flowchart illustrating processes implemented in the roadside portion traffic amount calculation device 1. FIG. 7 includes flowcharts illustrating processes at step S5 and step S6 in FIG. 6 in detail.

To begin with, the positional information acquisition unit 10 acquires positional information from the positional information storage unit 20 (S1, positional information acquisition step). Meanwhile, the road information acquisition unit 11 acquires road information from the road information storage unit 18 (S1). It should be noted that it is possible to perform the process of the roadside portion traffic amount calculation at a desired timing. When aiming to calculate the traffic amount every one week, for example, it is acceptable to acquire positional information for the one week and then perform the process of the roadside portion traffic amount calculation every one week.

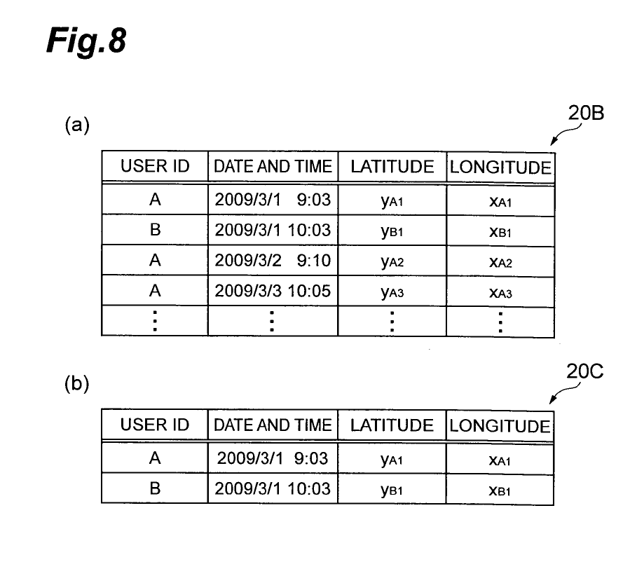

Subsequently, the positional information acquisition unit 10, when user IDs overlap among records of the positional information acquired, individualizes the records by user ID (S2). As described above, when a mobile terminal uses an application service using positional information, the positional information is measured and acquired, and accordingly there is a case in which positional information of the same user are acquired a plurality of times. In the present embodiment, after narrowing the positional information for one user to one piece of data, distribution of the positional information is determined. For example, when the positional information acquisition unit 10 acquires the positional information 20B in which three records whose user IDs are “A” are included as shown in FIG. 8(a), the positional information acquisition unit 10, referring to the information of date and time, individualizes the positional information by the user ID. FIG. 8(b) illustrates the positional information 20C when selecting the record whose date and time information indicates the oldest date and time and individualizing the records. It should be noted that, in the present embodiment, the case of selecting the record whose date and time information indicates the oldest date and time and individualizing the records is assumed, but it is acceptable to select the record whose date and time information indicates the newest date and time or select the record whose date and time information is the median among a plurality of records whose user IDs overlap to individualize the records. It should be noted that, when calculating the total amount of traffic or in a fourth embodiment described later, the process of individualizing the positional information by user IDs at the present step is omitted.

Next, the map matching processing unit 12 associates, with respect to the positional information acquired by the positional information acquisition unit 10, each piece of the positional information with each road by performing what is called a map matching process (S3). The map matching processing unit 12 then extracts the positional information associated with the road where a roadside portion traffic amount is to be summarized (S4).

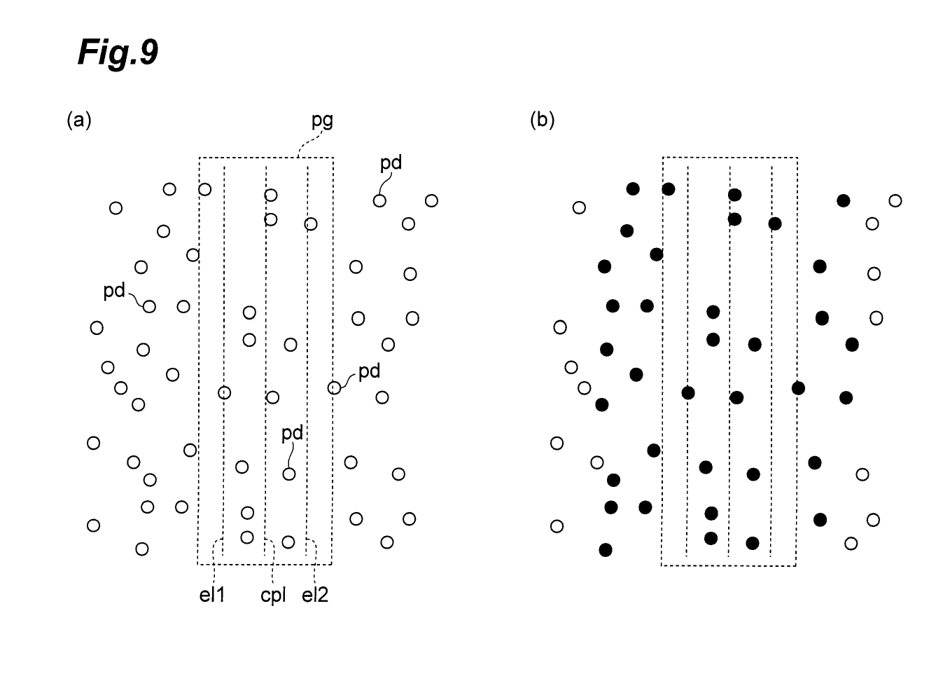

Referring to FIG. 9, processes at steps S3 and S4 will now be described. FIG. 9(a) is a diagram schematically illustrating a road depicted based on road information and locations pd indicated by each piece of the positional information. The locations pd depicted in FIG. 9(a) are associated with the road by the map matching process when it is highly probable to exist on the road represented by the polygon pg. In FIG. 9(b), for example, pieces of positional information which indicates locations represented by filled circles is extracted as positional information associated with the road to be summarized.

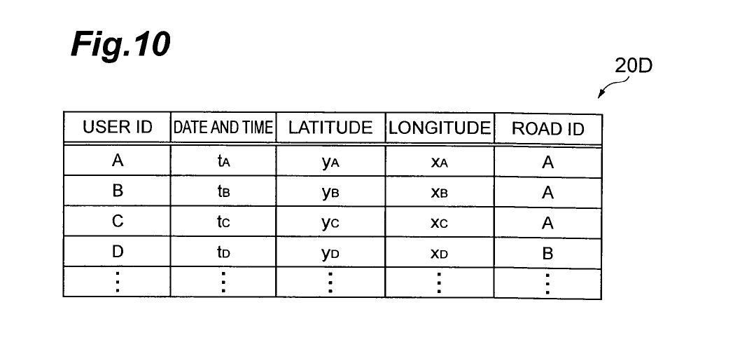

The processes at steps S3 and S4 can also be explained as follows. More specifically, if the pieces of the positional information at the completion of the process of step S2 are the positional information 20A illustrated in FIG. 2, the map matching processing unit 12 performs the map matching process for associating each piece of the positional information with the road to generate the positional information 20D associated with the road IDs as depicted in FIG. 10. As depicted in FIG. 10, pieces of positional information whose user IDs are “A”, “B”, and “C” are associated with the road ID “A”, and a piece of positional information whose user ID is “D” is associated with the road ID “B”. When the road ID of the road to be summarized is “A”, the map matching processing unit 12 extracts pieces of positional information whose user IDs are “A”, “B”, and “C” from the positional information 20D. It should be noted that information on the road to be summarized, for example, may be input via the input device 106 that the roadside portion traffic amount calculation device includes, or may be set in advance to be stored in storage means that the roadside portion traffic amount calculation device includes.

Subsequently, the positional information distribution determination unit 13 refers to the road information and, based on the positional relationship between the locations of the users indicated by the positional information and the road, determines a passage roadside portion where the locations of the users distribute with respect to each piece of the positional information (S5, positional information distribution determination step). More specifically, the positional information distribution determination unit 13 determines one of both roadside portions which is closer to the location of the user as the passage roadside portion regarding the positional information.

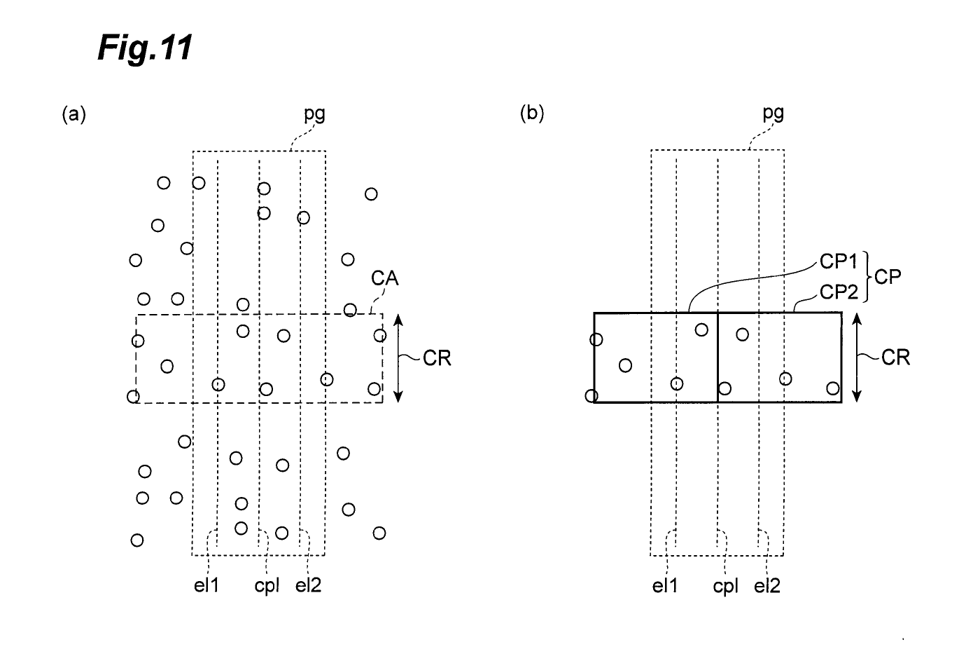

Processes at step S5 will now be described in detail with reference to FIG. 7(a) and FIG. 11. FIG. 11 includes diagrams schematically explaining the positional information distribution determination process. To begin with, the positional information distribution determination unit 13 extracts pieces of positional information contained within the measuring range (S10). For example, when the measuring range is set by an arrow CR in FIG. 11(a), the positional information distribution determination unit 13 extracts pieces of positional information contained in a frame CA. Subsequently, the positional information distribution determination unit 13 generates polygon data that includes all pieces of the positional information extracted at step S10 (S11). FIG. 11(b) is a diagram schematically illustrating a polygon CP generated at step S11. The positional information distribution determination unit 13 then divides the polygon CP together with the positional information by the center line cpl to generate a polygon CP1 and a polygon CP2 (S12). It should be noted that information on the measuring range (the arrow CR) in which the roadside portion traffic amount is to be calculated, for example, may be input via the input device 106 that the roadside portion traffic amount calculation device includes, or may be set in advance to be stored in the storage means that the roadside portion traffic amount calculation device includes.

Pieces of positional information contained in the polygon CP1 are positional information existing in locations that are closer to the roadside portion on the edge line el1 side (left side in the drawing) than to the roadside portion on the edge line el2 side (right side in the drawing) of the road indicated by the polygon pg. Therefore, the passage roadside portion of the pieces of the positional information contained in the polygon CP1 is determined to be the roadside portion on the edge line el1 side (left side of the drawing). On the other hand, the passage roadside portion of the pieces of the positional information contained in the polygon CP2 is determined to be the roadside portion on the edge line el2 side (right side of the drawing).

Next, the positional information summarizing unit 14 counts the number of pieces of the positional information for which the passage roadside portion has been determined by the positional information distribution determination unit 13 for each roadside portion, and summarizes the roadside portion traffic amount that is the amount of user traffic for each roadside portion (S6, positional information summarizing step). Processes at step S6 will now be described in detail with reference to FIG. 7(b) and FIG. 11(b). As depicted in FIG. 7(b), the positional information summarizing unit 14, by counting the number of pieces of positional information contained for each of the polygons CP1 and CP2 divided, summarizes the roadside portion traffic amount. In the example depicted in FIG. 11(b), the roadside portion traffic amount of the roadside portion on the edge line el1 side (left side of the drawing) is “5”, and the roadside portion traffic amount of the roadside portion on the edge line el2 side (right side of the drawing) is “4”.

Referring back to FIG. 6, the processing result output unit 15 outputs the roadside portion traffic amount summarized by the positional information summarizing unit 14 (S7, processing result output step). The output of the roadside portion traffic amount is performed with respect to, for example, the output device 107 such as a display that the roadside portion traffic amount calculation device 1 includes or another terminal device that can communicate via a network. In this manner, processes of the present embodiment are completed.

With the roadside portion traffic amount calculation device 1 according to the first embodiment described above, the passage roadside portion of users is determined based on the positional relationship between the locations of the users indicated by the positional information of the mobile terminal and the road, and the roadside portion traffic amount is summarized by counting the number of pieces of the positional information for which the passage roadside portion has been determined for each roadside portion. Accordingly, it is possible to obtain the amount of pedestrian traffic on each roadside portion of the road. Particularly, in the present embodiment, because one of both roadside portions which is closer to the location of the user is determined to be the passage roadside portion regarding the positional information, it is possible to appropriately determine the roadside portion where users may exist with high probability on the basis of the positional information. In addition, because determination of the passage roadside portion is performed with respect to the positional information extracted by the map matching process, the determination process is performed only with respect to the positional information of users who may exist with high probability on the road for which the traffic amount is to be summarized. Therefore, the accuracy of summarizing the roadside portion traffic amount improves.

### Second Embodiment

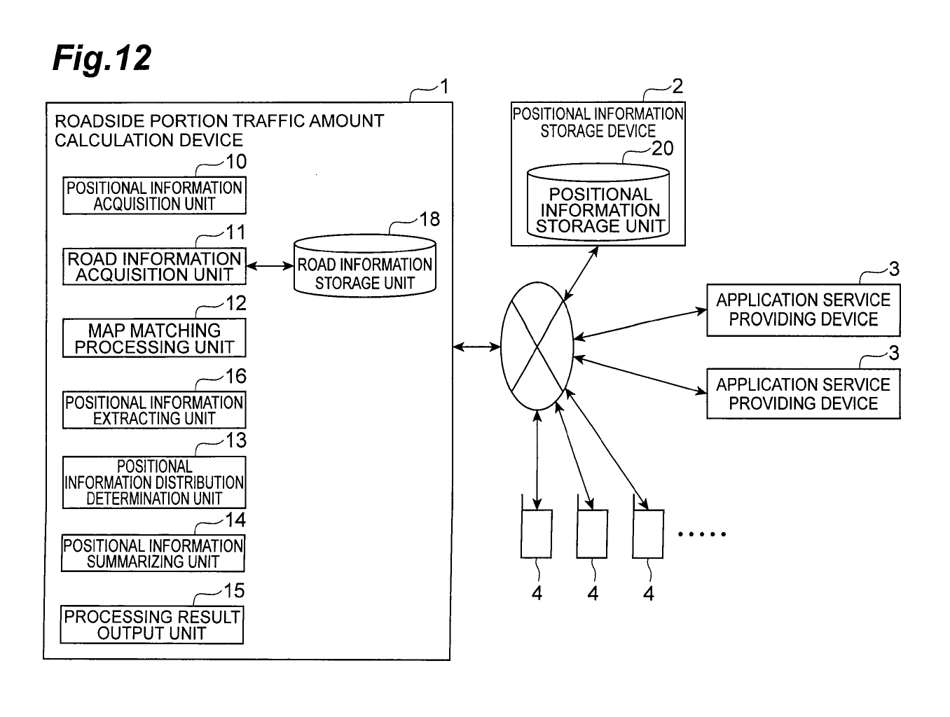

A roadside portion traffic amount calculation device 1 according to a second embodiment will be described hereinafter. FIG. 12 is a block diagram illustrating a functional structure of the roadside portion traffic amount calculation device 1 according to the second embodiment. The roadside portion traffic amount calculation device 1 according to the second embodiment differs from that of the first embodiment in further including a positional information extracting unit 16 (positional information extracting means).

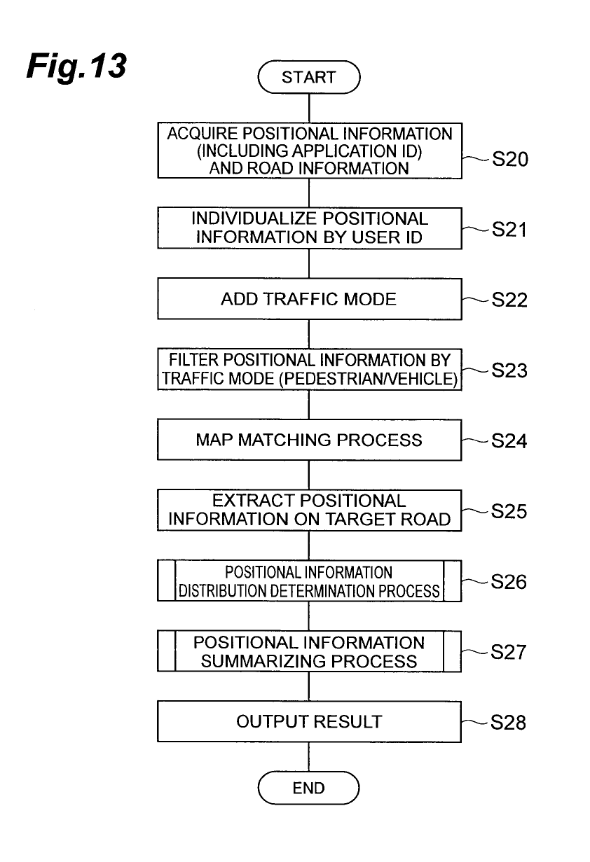

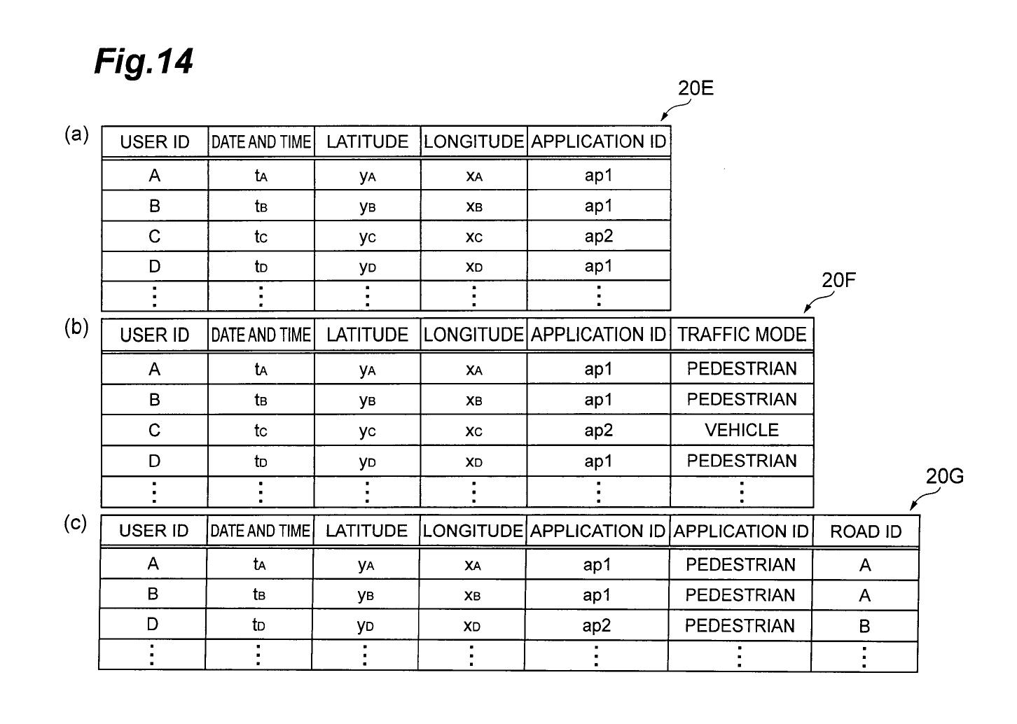

The positional information extracting unit 16 is a unit that refers to traffic mode information of the positional information acquired by the positional information acquisition unit 10 to extract positional information of users who are walking. In other words, in the second embodiment, the positional information includes the traffic mode information that is information to determine whether users whose locations are indicated by the positional information are walking or riding in vehicles. Referring to FIG. 13 and FIG. 14, details of processes in the roadside portion traffic amount calculation device 1 according to the second embodiment will be described hereinafter.

FIG. 13 is a flowchart illustrating the processes performed by the roadside portion traffic amount calculation device 1. FIG. 14 includes diagrams illustrating examples of a structure and contents of the positional information in the course of the process.

To begin with, the positional information acquisition unit 10 acquires positional information from the positional information storage unit 20 (S20). Meanwhile, the road information acquisition unit 11 acquires road information from the road information storage unit 18 (S20). FIG. 14(a) is a diagram illustrating one example of positional information acquired at step S20. In the positional information 20E indicated in FIG. 14(a), pieces of information on date and time, latitude, longitude, and an application ID are stored in association with user IDs. The application ID is information to identify an application service used by mobile terminals 4. This application service uses the positional information. It should be noted that the information of the application ID of the present embodiment constitutes traffic mode information that is information to determine whether users whose locations are indicated by the positional information are walking or riding in vehicles. The process at the subsequent step S21 is the same as the process at step S2 in the first embodiment.

Subsequently, the positional information extracting unit 16, based on the information of the application ID included in the positional information, adds a traffic mode to each piece of the positional information (S22). The process of adding the traffic mode will be described in detail hereinafter.

The positional information extracting unit 16 has in advance attribute information of applications indicating whether each of the applications identified by the application IDs is used while walking or used while riding on a vehicle, for example. The positional information extracting unit 16 then determines the traffic mode of each piece of the positional information on the basis of the attribute information. For example, when having attribute information indicating that the application identified by application ID “apt” is used by pedestrians, the positional information extracting unit 16 adds traffic mode “pedestrian” to each piece of the positional information of user ID “A”. FIG. 14(b) is a diagram illustrating the positional information 20F with the traffic mode added.

It should be noted that, in the present embodiment, as a method to add the traffic mode, the traffic mode is determined based on the application ID and the traffic mode information is given to the positional information, but this method is merely one example and it is not limited to this method. For example, it is acceptable that, based on the transition of positional information of the same user, the moving velocity of the positional information is calculated and the traffic mode of the positional information is determined based on the moving velocity. Alternatively, the positional information may have the traffic mode information in advance.

The positional information extracting unit 16 then performs a filtering process on the positional information by the traffic mode to extract positional information of pedestrians (S23). When the positional information on completion of the process at step S22 is the positional information 20F as depicted in FIG. 14(b), for example, the positional information extracting unit 16 extracts positional information of user IDs “A”, “B”, and “D”.

Subsequently, on the positional information 20F extracted by the positional information extracting unit 16, the map matching processing unit 12 performs a map matching process to generate the positional information 20G with a road ID added to each piece of the positional information (refer to FIG. 14(c)) (S24). Processes performed at steps S25 to S28 are the same as the processes depicted at steps S4 to S7 in the flowchart of FIG. 6.

With the roadside portion traffic amount calculation device 1 according to the second embodiment described above, because the positional information determined to be positional information of pedestrians are extracted and determination regarding the passage roadside portion is performed only with respect to the positional information thus extracted, determination regarding the passage roadside portion is not performed with respect to the positional information of users who are riding on vehicles. Therefore, the accuracy of summarizing the roadside portion traffic amount improves.

### Third Embodiment

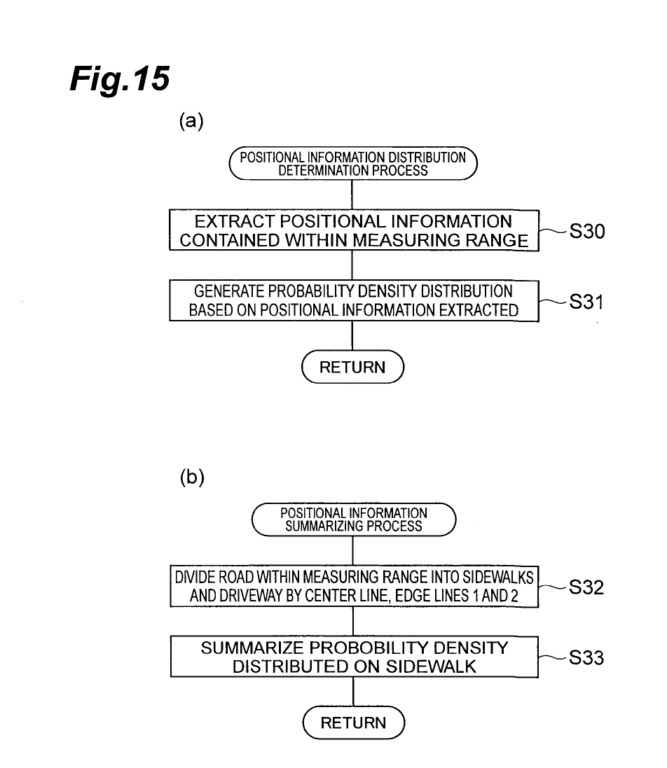

A roadside portion traffic amount calculation device 1 according to a third embodiment will be described hereinafter. The roadside portion traffic amount calculation device 1 according to the third embodiment has the same functional structure as that of the first embodiment or the second embodiment, but functions of the positional information distribution determination unit 13 and the positional information summarizing unit 14 differ from those of the first embodiment and the second embodiment. In addition, processes that the roadside portion traffic amount calculation device 1 according to the third embodiment can be depicted by the flowchart of FIG. 6 indicating the processes of the first embodiment, or the flowchart of FIG. 13 indicating the processes of the second embodiment, but processes of the positional information distribution determination process (S5, S26) and the positional information summarization process (S6, S27) differ from those of the first and the second embodiments. Referring to FIGS. 15 to 17, the roadside portion traffic amount calculation device 1 according to the third embodiment will be described in detail hereinafter. In particular, the processes of the positional information distribution determination process (S5, S26) and the positional information summarization process (S6, S27) will be described in detail.

FIG. 15(a) is a flowchart illustrating detailed processes of the positional information distribution determination process (S5, S26) in the third embodiment. FIG. 15(b) is also a flowchart illustrating detailed processes of the positional information summarization process (S6, S27) in the third embodiment.

To begin with, the positional information distribution determination unit 13 extracts positional information contained within the measuring range (S30). The process at step S30 is the same as the process at step S10 in the flowchart of FIG. 7.

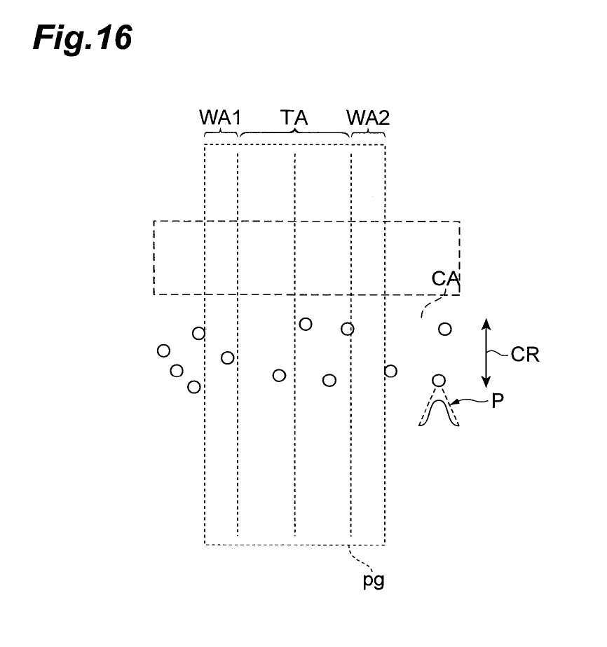

Subsequently, the positional information distribution determination unit 13, based on information of locations of positional information belonging to the measuring range CA and error information, generates probability density distribution with respect to the locations of the users (S31). FIG. 16 is a diagram schematically illustrating a state in which probability density distribution P is generated based on the positional information contained within the measuring range CA. It should be noted that FIG. 16 illustrates the state in which the probability density distribution P for one piece of positional information for illustrative purposes, but the positional information distribution determination unit 13 generates the probability density distribution P for all pieces of positional information contained within the measuring range CA.

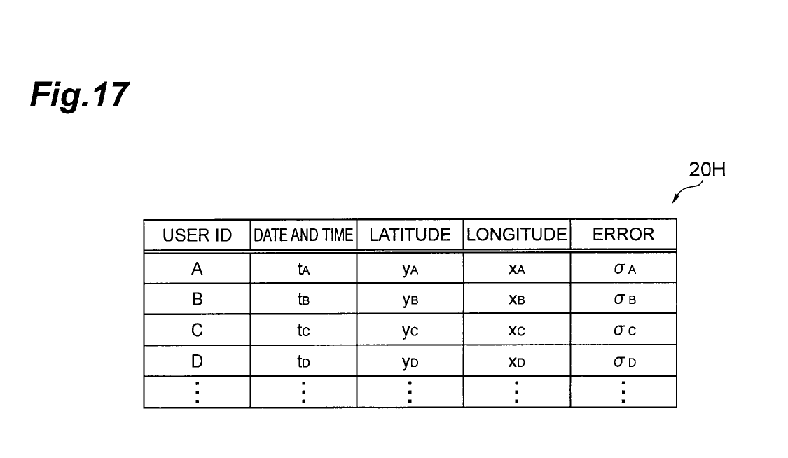

In the third embodiment, the positional information acquired by the positional information acquisition unit 10 includes error information regarding the locations of the users. FIG. 17 is a diagram illustrating the positional information 20H acquired by the positional information acquisition unit 10. As illustrated in FIG. 17, in the positional information 20H, pieces of information on date and time, latitude, longitude, and error are stored in association with user IDs. Because the error information included in the positional information arises from a method to acquire positional information of mobile terminals, a value that is set depending on an acquisition method of the positional information is associated with each piece of the positional information. For example, when errors in locations arising from the acquisition method of the positional information are large, the value set for error information is large and, in general, errors in positional information obtained by base stations accommodating mobile terminals 4 are larger than errors in positional information acquired by GPS devices of the mobile terminals 4.

Distribution of the locations of the users can be represented as probability density distribution for two-dimensional positions. The probability density distribution generated by the positional information distribution determination unit 13 is represented by the following formula (1), for example, as a function of latitude (y) and longitude (x).

$$f ( x , y ) = \frac{1}{2 {πσ}^{2}} exp [ - \frac{1}{2} \{ {( \frac{x - {p}_{x}}{σ} )}^{2} + {( \frac{y - {p}_{y}}{σ} )}^{2} \} ] \qquad ( 1 )$$

In Formula (1), σ is a value of error information, p_{X} and p_{Y} are values of latitude and longitude in positional information.

Furthermore, because the probability density distribution generated herein is used to determine a passage roadside portion where positional information is distributed, the positional information distribution unit 13, by converting a coordinate axis such that the width direction of the road becomes the x-axis direction, may express the probability density distribution as distribution for one-dimensional positions (x-axis coordinate). In this case, the probability density distribution is represented by the following formula (2), for example.

$$f ( x ) = \frac{1}{\sqrt{2 π} σ} exp [ - \frac{1}{2} {( \frac{x - μ}{σ} )}^{2} ] \qquad ( 2 )$$

In Formula (2), σ is a value of error information, μ is the position on the x-axis set in the width direction of the road onto which the position indicated by latitude and longitude of the positional information is projected.

Subsequently, referring to FIG. 15(b), the positional information summarizing unit 14, based on road information such as the polygon pg, the center line cpl, the edge line 1 el1, and the edge line 2 el2, divides the area of the road contained within the measuring range CA into the sidewalks WA1 and WA2, and the driveway TA (refer to FIG. 16) (S32). Subsequently, the positional information summarizing unit 14, out of a plurality of probability density distributions P generated by the positional information distribution determination unit 13 at step S31, adds up probability density contained within the measuring range CA and distributed in the sidewalks WA1 and WA2 for each roadside portion to summarize the roadside portion traffic amount (S33).

With the roadside portion traffic amount calculation device 1 according to the third embodiment described above, the locations of the users are expressed as probability density distribution on the basis of error information included in positional information, whereby the locations of the users are expressed more accurately. In addition, based on the probability density distribution generated, the roadside portion traffic amount is summarized by adding up probability density distributed in the area of sidewalk of the road for each roadside portion, whereby the accuracy of the roadside portion traffic amount improves.

### Fourth Embodiment

A roadside portion traffic amount calculation device 1 according to a fourth embodiment will be described hereinafter. The roadside portion traffic amount calculation device 1 according to the fourth embodiment has the same functional structure as that of the first embodiment or the second embodiment, but the functions of the positional information distribution determination unit 13 and the positional information summarizing unit 14 differ from those of the first embodiment and the second embodiment.

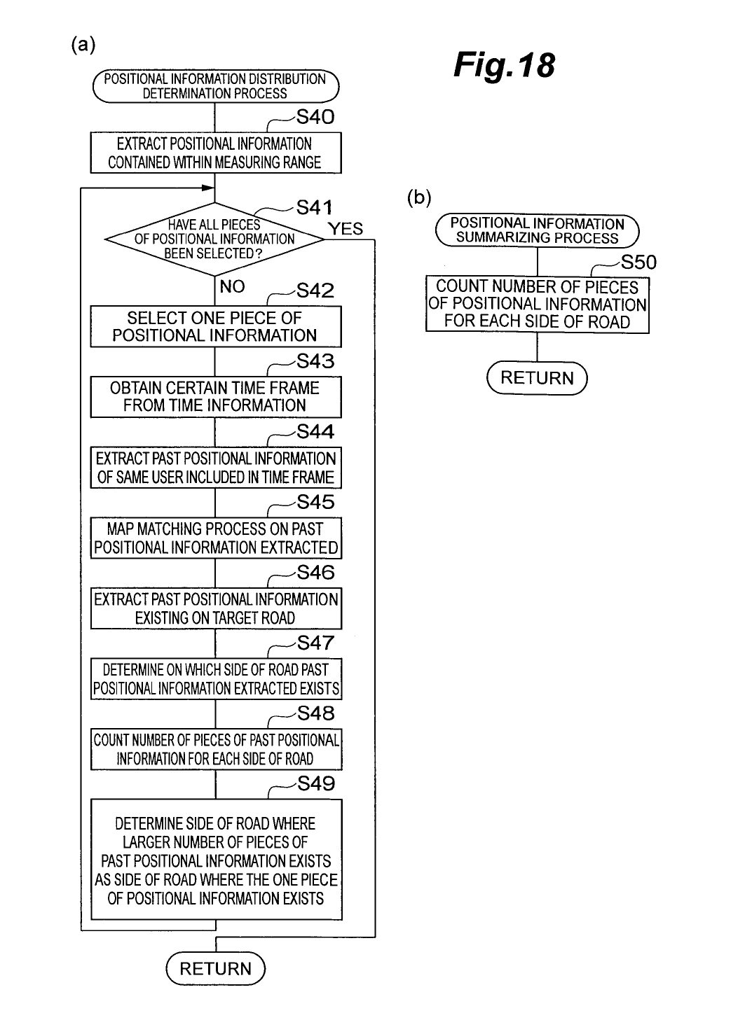

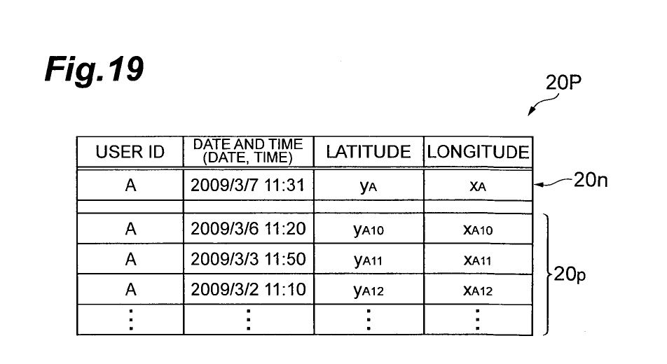

Processes that the roadside portion traffic amount calculation device 1 according to the fourth embodiment performs can be depicted by the flowchart of FIG. 6 indicating the processes of the first embodiment or the flowchart of FIG. 13 indicating the processes of the second embodiment, but processes of the positional information distribution determination process (S5, S26) and the positional information summarization process (S6, S27) differ from those of the first and the second embodiments. Referring to FIG. 18 and FIG. 19, the roadside portion traffic amount calculation device 1 according to the fourth embodiment will be described in detail hereinafter. In particular, the processes of the positional information distribution determination process (S5, S26) and the positional information summarization process (S6, S27) will be described in detail.

FIG. 18(a) is a flowchart illustrating detailed processes of the positional information distribution determination process (S5, S26) in the fourth embodiment. FIG. 18(b) is also a flowchart illustrating detailed processes of the positional information summarization process (S6, S27) in the third embodiment.

To begin with, the positional information distribution determination unit 13 extracts positional information contained within the measuring range (S40). The process at step S40 is the same as the process at step S10 in the flowchart of FIG. 7.

Subsequently, the positional information distribution determination unit 13 determines if all pieces of positional information extracted at step S40 have been selected (S41). If all pieces of the positional information are determined to have been selected, the positional information distribution determination process is ended. On the other hand, if all pieces of the positional information are not determined to have been selected, the procedure goes to step S42. The process at step S41 is a process to perform determination regarding the passage roadside portion with respect to all pieces of positional information extracted at step S40.

When all pieces of the positional information are not determined to have been selected at step S41, the positional information distribution determination unit 13, out of the positional information extracted at step S40, from positional information for which the passage roadside portions have not been determined, selects one piece of positional information (positional information to be summarized) (S42).

Subsequently, the positional information distribution determination unit 13 obtains a certain time frame on the basis of information on date and time (time) of the positional information selected at step S42 (S43). The positional information distribution determination unit 13 then extracts positional information in which the time falls within the time frame obtained (a predetermined time frame) and which is positional information of the same user on the past days (S44). FIG. 19 is a diagram illustrating one piece of positional information 20n (positional information to be summarized) selected at step S42 and the past pieces of positional information 20p (past positional information) acquired at step S44.

When a condition regarding the “certain time frame” at step S43 is “30 minutes before and after the time of reference”, for example, the information on date and time of the one piece of the positional information 20n indicates “2009/3/7 11:31”, and accordingly the positional information distribution determination unit 13 extracts pieces of positional information of the same user in which the date and time information falls within “11:01 to 12:01” and before “2009/3/6”. The positional information 20p in FIG. 19 indicates the positional information thus acquired. It should be noted that the condition regarding to the “certain time frame” is not limited to the above-mentioned condition, and may be set to “out of hour and minute of the time of reference, hour is the same as this hour”, for example.

Subsequently, the positional information distribution determination unit 13 performs a map matching process on the past positional information 20p acquired at step S44 (S45), and extracts the past positional information 20p that belongs to the road to be summarized (S46). Processes of the map matching process (S45) performed on the past positional information 20p and the positional information extracting process (S46) are the same as the processes performed on positional information at steps S3 and S4 in FIG. 6, for example (the first embodiment).

Next, the positional information distribution determination unit 13 determines to which roadside portion out of both roadside portions the past positional information 20p extracted at step S46 (S47), and counts the number of pieces of the past positional information 20p for which the roadside portion to which it belongs has been determined for each roadside portion (S48). The determination process at step S47 is performed, for example, by determining the roadside portion that is closer to the locations of the users indicated by the past positional information 20p to be the roadside portion to which the past positional information 20p belongs. More specifically, it is performed in the same manner as the determination process that is used for determination regarding the passage roadside portion of positional information at step S5 in FIG. 6 and at steps S10 to S12 in FIG. 7 (the first embodiment).

The positional information distribution determination unit 13 then determines the roadside portion of which the number of pieces of the past positional information 20p counted at step S48 is larger to be the passage roadside portion of the one piece of the positional information 20n selected at step S42 (S49), and the procedure goes back to step S41. As described above, when all pieces of positional information are determined to have been selected at step S41, the positional information distribution determination process is ended, and subsequently the positional information summarizing process is performed.

Subsequently, referring to FIG. 18(b), the positional information summarizing process will be described. The positional information summarizing unit 14 counts the number of pieces of the positional information for which the passage roadside portion has been determined by the positional information distribution determination process for each roadside portion to summarize the roadside portion traffic amount (S50). The processing result output unit 15 then outputs the roadside portion traffic amount summarized.

In the roadside portion traffic amount calculation device 1 of the fourth embodiment described above, the past positional information of the same user is acquired for each piece of positional information to be summarized, distribution of the past positional information is determined for each roadside portion, and the roadside portion of which the number of pieces of the past positional information is larger is determined to be the passage roadside portion regarding the positional information to be summarized. Accordingly, based on the tendency of user passage on the roadside portions in the past, distribution for either of the roadside portions of the positional information to be summarized is determined. Therefore, the accuracy of the roadside portion traffic amount improves. In addition, the positional information acquisition unit 10 obtains a certain time frame on the basis of information on the time of the positional information to be summarized, and acquires positional information in which the time falls within the time frame obtained and which is positional information of the same user on the past days from the positional information storage unit 20 to provide it for determination regarding the passage roadside portion. Accordingly, it is possible to perform determination more appropriately considering the tendency of user passage on the roadside portion in the past.

### Fifth Embodiment

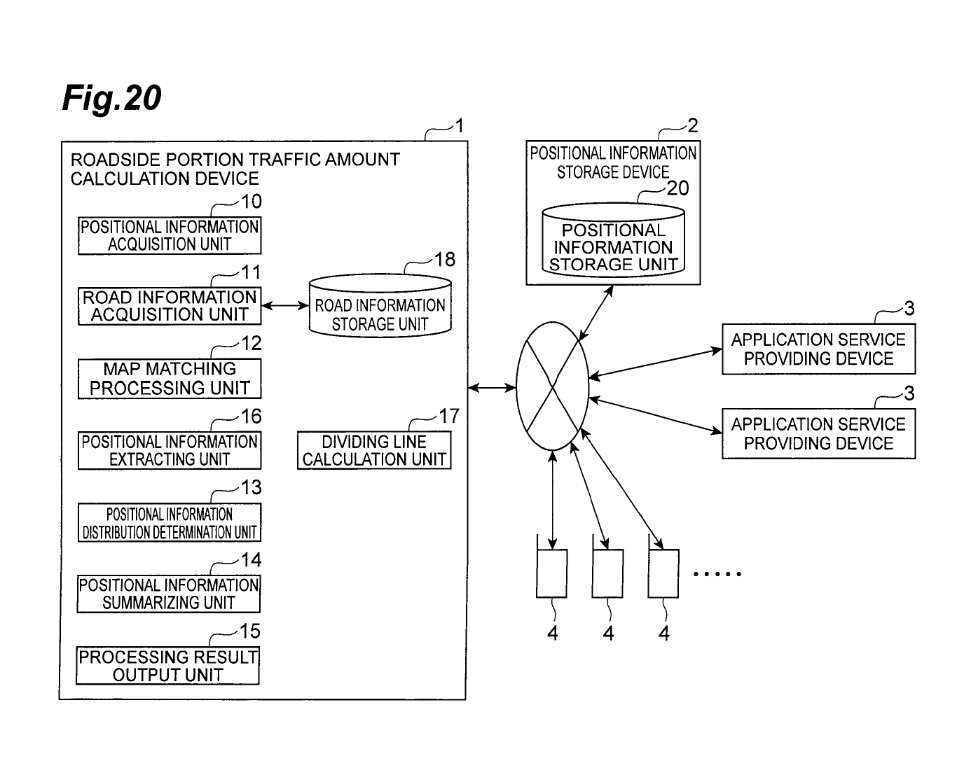

Referring to FIG. 20, a roadside portion traffic amount calculation device 1 according to a fifth embodiment will be described hereinafter. FIG. 20 is a block diagram illustrating a functional structure of the roadside portion traffic amount calculation device 1 according to the fifth embodiment. The roadside portion traffic amount calculation device 1 according to the fifth embodiment includes the positional information extracting unit 16 similarly to the second embodiment, and further includes a dividing line calculation unit 17 (dividing line calculation means). In addition, functions of the positional information distribution determination unit 13 and the positional information summarizing unit 14 differ from those of the first to the fourth embodiments.

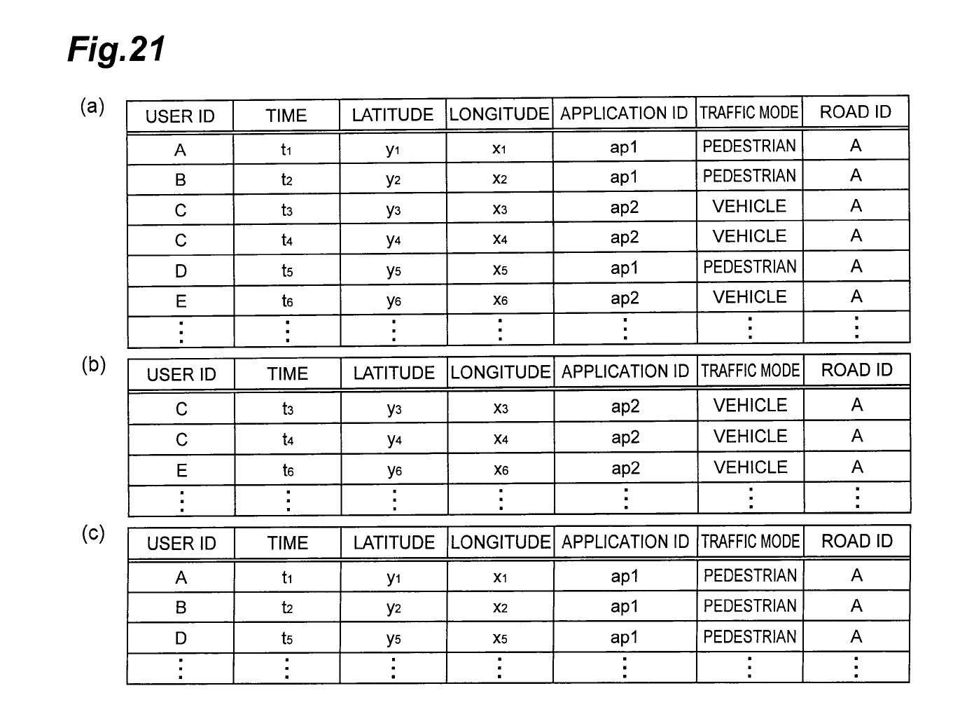

The dividing line calculation unit 17 is a unit that, based on the moving direction of positional information of users who are riding on vehicles out of the positional information acquired by the positional information acquisition unit 10, calculates a dividing line that divide the road into areas in each of which vehicles moving in the same direction are distributed and that contain the respective roadside portions. Referring to FIGS. 21 to 24, a calculation process of the dividing line by the dividing line calculation unit 17 will be described hereinafter.

To begin with, the dividing line calculation unit 17, from the positional information acquired by the positional information acquisition unit 10, extracts positional information of users who are riding on vehicles. Extraction of the positional information is, as described in the second embodiment, performed with reference to the traffic mode information in the positional information. The dividing line calculation unit 17 extracts positional information that has the traffic mode information indicative of being riding on a vehicle as positional information of users who are riding on vehicles. FIG. 21(a) is a diagram illustrating an example of the positional information acquired by the positional information acquisition unit 10. It should be noted that FIG. 21(a) indicates the positional information for which determination and addition of the traffic mode have been performed and that has been associated with the road to which the positional information belongs by the map matching process. The dividing line calculation unit 17, from the positional information as exemplified in FIG. 21(a), extracts positional information whose traffic mode information is “vehicle”. FIG. 21(b) is an example of the positional information extracted by the dividing line calculation unit 17. Every piece of the traffic mode information of the positional information depicted in FIG. 21(b) is “vehicle”. It should be noted that FIG. 21(c) is an example of the positional information extracted by the positional information extracting unit 16 (refer to the second embodiment). Every piece of the traffic mode information of the positional information depicted in FIG. 21(c) is “pedestrian”.

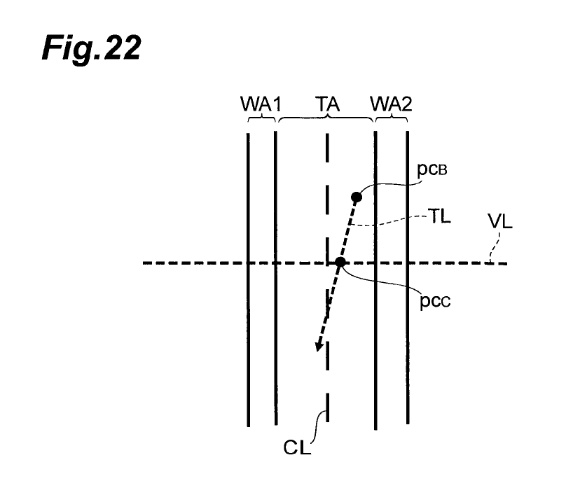

Subsequently, the dividing line calculation unit 17 determines the moving direction of the positional information extracted. FIG. 22 is a diagram illustrating an example of determination of the moving direction of the positional information. In FIG. 22, the road including the driveway TA and the sidewalks WA1 and WA2 is depicted, and on the road, the positional information pc_{C} whose moving direction is to be determined and the positional information pc_{B} that is the same user's positional information just before the positional information pc_{C} on a time-series basis are depicted. It should be noted that, for moving direction determining purposes, the dividing line calculation unit 17, out of extending directions of the road to be processed, makes any optional one direction upward, and makes the direction reverse to the one direction downward. (the upward direction and the downward direction on the plane of FIG. 22)

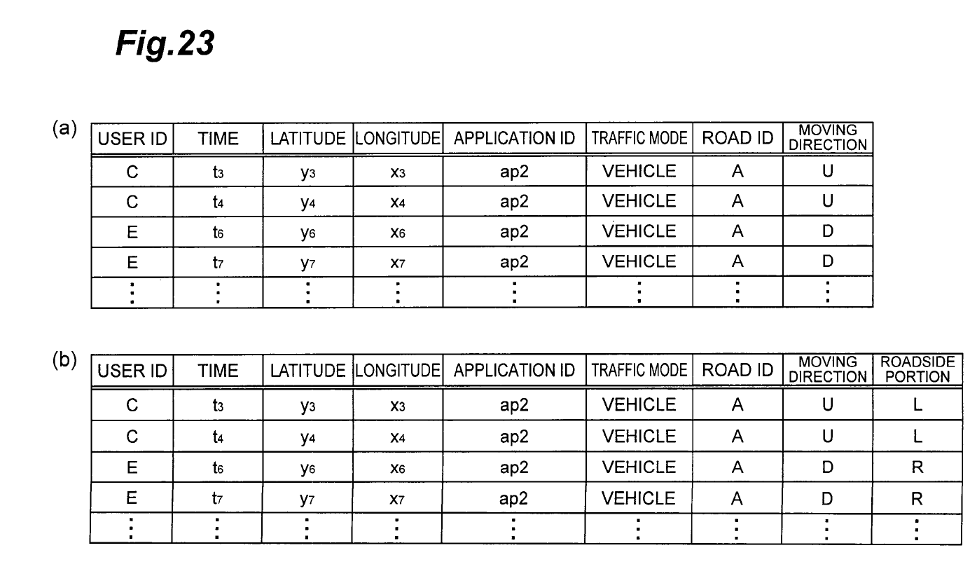

For determination of the moving direction, the dividing line calculation unit 17 sets the normal line VL to the center line CL, which passes through the positional information pc_{C}. In addition, the dividing line calculation unit 17 generates a trajectory TL extending from the positional information pc_{B} to the positional information pc_{C}. The dividing line calculation unit 17 then determines the moving direction of the positional information pc_{C} on the basis of the direction of the trajectory TL crossing the normal line VL at the position of the positional information pc_{C}. In the example depicted in FIG. 22, the dividing line calculation unit 17 determines the moving direction of the positional information pc_{C} to be downward. FIG. 23(a) is a diagram illustrating an example of positional information whose moving directions have been determined. As depicted in FIG. 23(a), each piece of the positional information has information of the upward direction “U” or the downward direction “D” as the moving direction determined.

Subsequently, the dividing line calculation unit 17 determines the roadside portion where vehicles indicated in the positional information are traveling. For example, because vehicles travel on the left in Japan, the dividing line calculation unit 17 determines the passage roadside portion regarding the positional information whose moving direction has been determined to be upward to be on the left, and determines the passage roadside portion regarding the positional information whose moving direction has been determined to be downward to be on the right. FIG. 23(b) is a diagram illustrating an example of positional information for which roadside portions where vehicles are traveling have been determined. As depicted in FIG. 23(b), positional information whose moving direction is upward “U” has information of the left side “L” as the roadside portion where vehicles are traveling, and positional information whose moving direction is downward “D” has information of the right side “R” as the roadside portion where vehicles are traveling. It should be noted that, in the case of a country where vehicles travel on the right, positional information whose moving direction is upward “U” is associated with information of the right side “R” as the roadside portion where vehicles are traveling, and positional information whose moving direction is downward “D” is associated with information of the left side “L” as the roadside portion where vehicles are traveling.

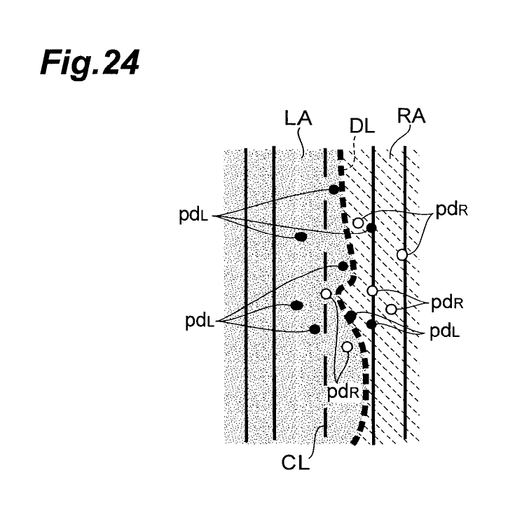

The dividing line calculation unit 17 then calculates a dividing line that divides the road into areas in each of which vehicles traveling in the same direction are distributed and each roadside portion is contained based on the moving direction of the positional information. FIG. 24 is a diagram illustrating an example of a dividing line DL calculated by the dividing line calculation unit. In FIG. 24, pieces of positional information pd_{L} that have been determined to be moving on the roadside portion on the left and pieces of positional information pd_{R} that have been determined to be moving on the roadside portion on the right are indicated. The dividing line calculation unit 17 calculates the dividing line DL on the basis of distribution of the pieces of the positional information pd_{L} and pd_{R}. The road is divided into an area LA containing the left roadside portion and an area RA containing the right roadside portion by the dividing line DL.

Calculation of the dividing line DL is performed by using a technique such as a support vector machine (SVM). The SVM is one of pattern recognition techniques that are well-known to the skilled person, and it uses known data and obtains a hyperplane that divides points on n-dimensional space into two. More specifically, the SVM is a technique that uses linear threshold elements that are the simplest as a neuron model to construct a two-class pattern classifier, and parameters for the linear threshold elements are learned by principles such as a sample set to margin maximization.

The positional information distribution determination unit 13, by determining in which area of LA or RA divided by the dividing line DL pieces of positional information of pedestrians extracted by the positional information extracting unit 16 are distributed, determines the passage roadside portion of the positional information. For example, the positional information distribution determination unit 13, by determining to which area of LA or RA locations indicated in positional information of pedestrians belong, can determine the passage roadside portion regarding the positional information.

In addition, the positional information distribution determination unit 13, similarly to the third embodiment, based on locations of positional information of pedestrians and error information, generates probability density distribution regarding locations of the users and, by obtaining distributions with respect to the areas LA and RA for the probability density, can determine the passage roadside portion regarding the positional information.

The positional information summarizing unit 14 counts the number of pieces of the positional information of pedestrians for which the passage roadside portion has been determined by the positional information distribution determination unit 13 for each passage roadside portion within the measuring range of the road to be summarized, and summarizes the roadside traffic amount that is the amount of user traffic for each roadside portion. In addition, when the passage roadside portion of the positional information of pedestrians is represented by the probability density distribution, the positional information summarizing unit 14, out of a plurality of probability density distributions generated by the positional information distribution determination unit 13, adds up the probability density distributed in each of the area LA and RA divided by the dividing line DL to summarize the roadside portion traffic amount.

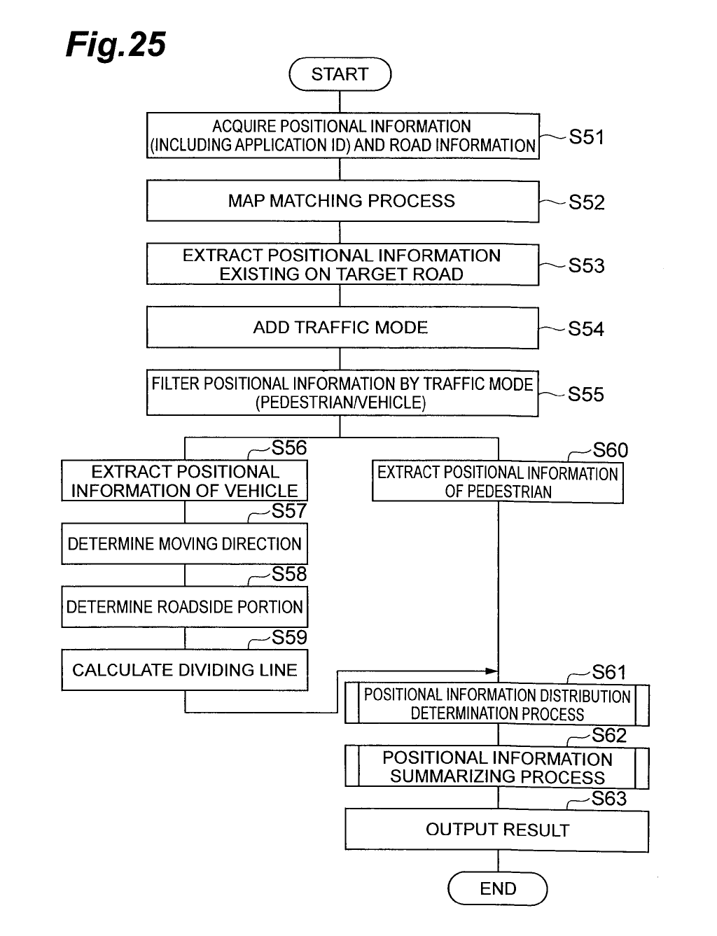

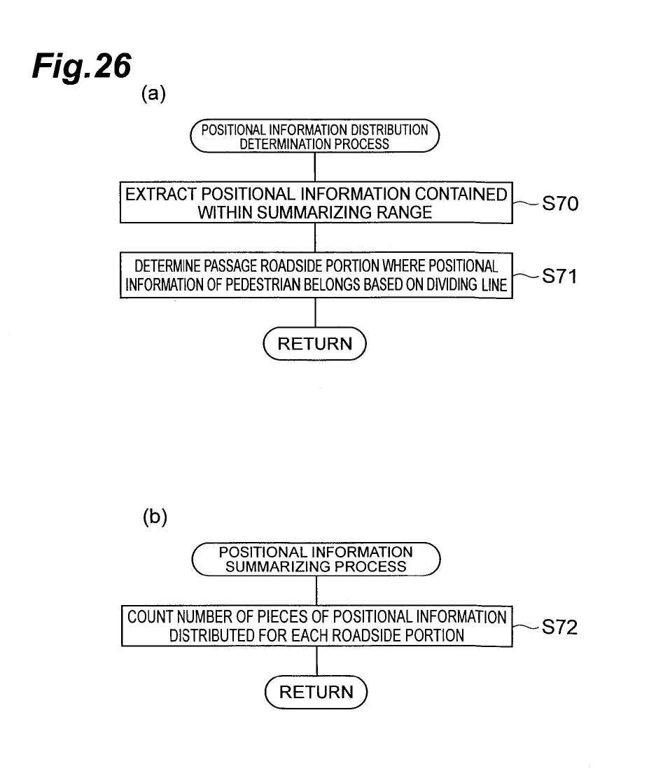

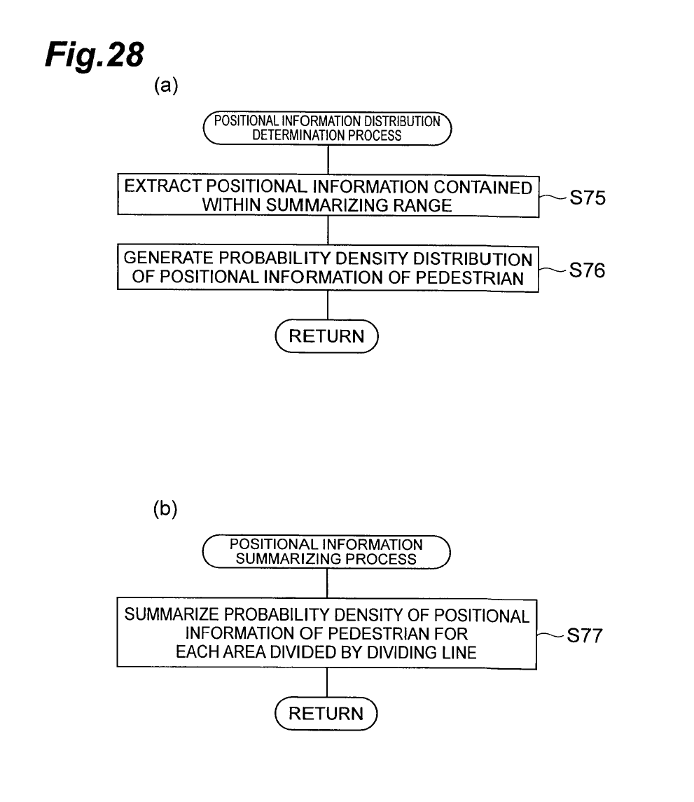

Next, referring to FIG. 25, the operation of the roadside portion traffic amount calculation device 1 according to the fifth embodiment will be described hereinafter. FIG. 25 is a flowchart illustrating processes performed by the roadside portion traffic amount calculation device 1. FIG. 26 and FIG. 28 are flowcharts both illustrating processes at steps S61 and S62 in FIG. 25.

Processes at steps S51 to S54 are the same as the processes steps S20, S24, S25, and S22 depicted in the flowchart in FIG. 13 of the second embodiment, respectively. An example of positional information on completion of the process at step S54 is depicted in FIG. 21(a). It should be noted that it is possible to perform the processes at steps S52 to S54 in any optional order.

Subsequently, the dividing line calculation unit 17 performs a filtering process on the positional information by the traffic mode (S55), and extracts positional information of vehicles (S56). An example of the positional information on completion of the process at step S56 is depicted in FIG. 21(b).

Meanwhile, the positional information extracting unit 16 performs a filtering process on the positional information by the traffic mode (S55), and extracts positional information of pedestrians (S60). An example of the positional information on completion of the process at step S61 is depicted in FIG. 21(c). It should be noted that it is acceptable to, at step S60, similarly to step S2 in the flowchart of FIG. 6, perform a process to individualize pieces of positional information whose user IDs overlap.

Subsequently to the process at step S56, the dividing line calculation unit 17 determines the moving direction of the positional information extracted (S57). Next, the dividing line calculation unit 17 determines the roadside portion where the vehicles indicated in the positional information are travelling (S58). In addition, the dividing line calculation unit 17, based on the moving direction of the positional information, calculates a dividing line that divides the road into areas in each of which vehicles traveling in the same direction are distributed and that contain the respective roadside portions (S59).

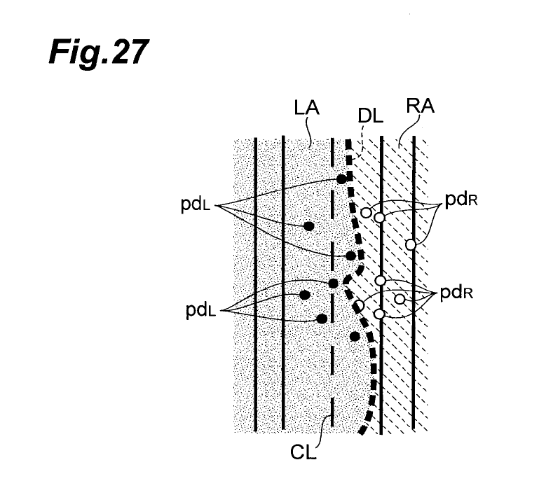

Subsequently, the positional information distribution determination unit 13 performs a positional information distribution determination process (S61). As depicted in FIG. 26(a), for example, the positional information distribution determination unit 13 extracts pieces of positional information of pedestrians within a summarizing range (S70) and, by determining in which area LA or RA divided by the dividing line DL the pieces of the positional information extracted are distributed, determines the passage roadside portion of the pieces of the positional information (S71). FIG. 27 is a diagram illustrating an example of the pieces of the positional information whose passage roadside portions have been determined. As depicted in FIG. 27, the positional information distribution determination unit 13 determines the passage roadside portion of the positional information pd_{L} distributed in the area LA to be the left roadside portion, and determines the passage roadside portion of the positional information pd_{R} distributed in the area RA to be the right roadside portion.

In addition, the positional information summarizing unit 14 counts the number of pieces of the positional information of pedestrians whose passage roadside portions have been determined by the positional information distribution determination unit 13 for each of the left and the right passage roadside portions (S72), and summarizes the positional information (S62). In the example depicted in FIG. 27, the amount of traffic on the left roadside portion is “7” and the amount of traffic on the right roadside portion is “7”.

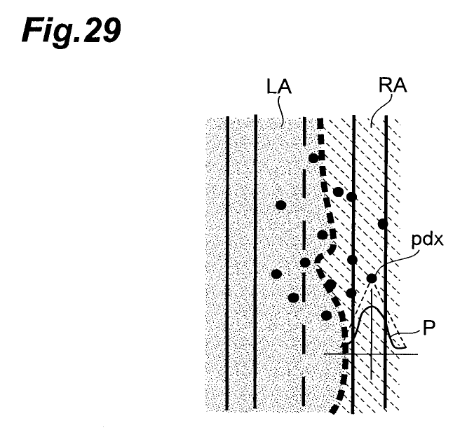

Alternatively, the positional information distribution determination process (S61) and the positional information summarizing process (S62) may be performed as depicted in FIG. 28. More specifically, the positional information distribution determination unit 13, as depicted in FIG. 28(a), extracts pieces of positional information of pedestrians contained within the summarizing range (S75) and, based on locations of positional information of pedestrians and error information, generates probability density distribution (S76). FIG. 29 is a diagram illustrating an example of probability density distribution P generated on the positional information pd_{X}. It should be noted that FIG. 29 illustrates the probability density distribution P in two dimensions for illustrating purposes, but actually three-dimensional probability density distribution is generated.

Subsequently, the positional information summarizing unit 14, as depicted in FIG. 28(b), out of a plurality of probability density distributions generated by the positional information distribution determination unit 13, adds up the probability density distributed in each area of LR and RA divided by the dividing line DL to summarize the positional information (S77).

Referring back to FIG. 25, the processing result output unit 15 outputs the roadside portion traffic amount that is the amount of positional information for each roadside portion summarized by the positional information summarizing unit 14 (S63). In this manner, the process of the present embodiment is ended.

With the roadside portion traffic amount calculation device 1 according to the fifth embodiment described above, based on the moving direction of positional information of vehicles, the road is divided by the dividing line into two areas that contain the respective roadside portions at both ends of the road. This makes it possible to recognize the boundary between both roadside portions of the road. In addition, by determining in which area divided by the dividing line pieces of positional information of pedestrians are distributed, it is possible to determine the passage roadside portions of the pedestrians. Furthermore, because the dividing line is calculated based on the moving direction of positional information of vehicles the positions of which are measured by the same method as that of positional information of pedestrians to be summarized, when determining the passage roadside portion of the positional information of the pedestrians, it is possible to cancel errors in measurement of the positions of the positional information of the pedestrians.

### REFERENCE SIGNS LIST

1 . . . roadside portion traffic amount calculation device, 2 . . . positional information storage device, 3 . . . application service providing device, 4 . . . mobile terminal, 10 . . . positional information acquisition unit, 11 . . . road information acquisition unit, 12 . . . map matching processing unit, 13 . . . positional information distribution determination unit, 14 . . . positional information summarizing unit, 15 . . . processing result output unit, 16 . . . positional information extracting unit, 17 . . . dividing line calculation unit, 18 . . . road information storage unit, 20 . . . positional information storage unit, 20A-20H . . . positional information

1-10. (canceled)

11. A roadside portion traffic amount calculation device that, based on positional information indicating locations of users, calculates a number of users of mobile terminals moving on each roadside portion positioned on both ends in a width direction of a road, the roadside portion traffic amount calculation device comprising:
a positional information acquisition section configured to acquire one or more pieces of the positional information;
a positional information distribution determination section configured to refer to road information that is information regarding the road and, based on a positional relationship between the locations of the users indicated by the positional information and the road, determine a passage roadside portion that is a roadside portion in which the locations of the users are distributed for each piece of the positional information;
a positional information summarizing section configured to count a number of pieces of the positional information for which the passage roadside portion has been determined by the positional information distribution determination section for each of the roadside portions, and summarize a roadside portion traffic amount that is an amount of user traffic on each of the roadside portions;
a processing result output section configured to output the roadside portion traffic amount summarized by the positional information summarizing section; and
a map matching processing section, wherein
the road information includes information regarding location of the road;
the map matching processing section, based on the information regarding the location of the road included in the road information, performs a map matching process on the positional information acquired by the positional information acquisition section, and extracts the positional information that is associated with a road the roadside portion traffic amount of which is to be summarized; and
the positional information distribution determination section determines the passage roadside portion of the positional information extracted by the map matching processing section.

12. The roadside portion traffic amount calculation device according to claim 11, wherein
the positional information includes error information regarding the locations of the users;
the road information includes information regarding an area of a sidewalk that lies at each of the roadside portions of the road;
the positional information distribution determination section, based on the locations and the error information of the positional information, generates probability density distribution regarding the locations of the users; and
the positional information summarizing section, out of a plurality of probability density distributions generated by the positional information distribution determination section, adds up the probability density distributed in the area of the sidewalk of the road for each roadside portion to summarize the roadside portion traffic amount.

13. The roadside portion traffic amount calculation device according to claim 11, wherein
the positional information includes traffic mode information that is information to determine whether the users whose locations are indicated by the positional information are walking or riding on vehicles; and
the roadside portion traffic amount calculation device further comprises:
a dividing line calculation section configured to, by referring to the traffic mode information of the positional information acquired by the positional information acquisition section, extract the positional information indicating locations of users riding on vehicles and, based on a moving direction of users whose locations are indicated by the positional information extracted, calculate a dividing line that divides the road into areas in each of which vehicles traveling in a same direction are distributed and that contain the respective roadside portions; and
a positional information extracting section configured to, by referring to the traffic mode information of the positional information acquired by the positional information acquisition section, extract the positional information indicating locations of users who are walking, wherein
the positional information distribution determination section, by determining in which area divided by the dividing line pieces of the positional information indicating locations of users who are walking extracted by the positional information extracting section are distributed, determines passage roadside portions of users whose locations are indicated by the positional information.

14. The roadside portion traffic amount calculation device according to claim 13, wherein
the positional information includes error information regarding the locations of the users;
the positional information distribution determination section, based on the locations of the positional information and the error information, generates probability density distribution regarding the locations of the users; and
the positional information summarizing section, out of a plurality of probability density distributions generated by the positional information distribution determination section, adds up the probability density distributed in each area divided by the dividing line in the road to summarize the roadside portion traffic amount.

15. The roadside portion traffic amount calculation device according to claim 13, wherein the dividing line calculation section, based on transition of positional information of a same user that is continuous on a time-series basis, determines a moving direction of users whose locations are indicated by positional information.

16. The roadside portion traffic amount calculation device according to claim 11, wherein the positional information distribution determination unit determines one of both roadside portions which is closer to the location of the user to be the passage roadside portion regarding the positional information.

17. The roadside portion traffic amount calculation device according to claim 11, wherein
the positional information includes, together with the information indicating the locations of the users of the mobile terminals, date and time information that is information on date and time when the users exist in the locations;
the positional information distribution determination section extracts past positional information that is positional information, in a period before being specified by the date and time information included in summarizing target positional information that is positional information for which the roadside portion traffic amount is to be summarized, indicating locations of users of the summarizing target positional information for each of the summarizing target positional information, determines the roadside portion where the locations of the users indicated in the past positional information extracted are distributed with respect to all of the past positional information corresponding to the summarizing target positional information, counts a number of pieces of the past positional information for which distribution of the locations has been determined for each of the roadside portions, and determines the roadside portion where the number of the pieces of the past positional information counted is larger to be the passage roadside portion regarding the summarizing target positional information; and
the positional information summarizing section counts a number of pieces of the summarizing target positional information of which the passage roadside portion is determined by the positional information distribution determination section for each of the roadside portions, and summarizes a roadside portion traffic amount that is an amount of user traffic for each of the roadside portions.

18. The roadside portion traffic amount calculation device according to claim 17, wherein the positional information acquisition section acquires the past positional information in which, within a predetermined time frame including time indicated in the date and time information of the summarizing target positional information, the time indicated in the date and time information falls.

19. The roadside portion traffic amount calculation device according to claim 11, further comprising:
a positional information extracting section, wherein
the positional information includes traffic mode information that is information to determine whether the users whose locations are indicated by the positional information are walking or riding on vehicles;
the positional information extracting section refers to the traffic mode information of the positional information acquired by the positional information acquisition section, and extracts the positional information indicating locations of users who are walking; and
the positional information distribution determination section determines the passage roadside portions of the positional information extracted by the positional information extracting section.

20. A roadside portion traffic amount calculation method for, based on positional information indicating locations of users, calculating a number of users moving on each roadside portion positioned on both ends in a width direction of a road, the roadside portion traffic amount calculation method comprising:
a positional information acquiring step of acquiring one or more pieces of the positional information;
a positional information distribution determination step of referring to road information that is information regarding the road and, based on a positional relationship between the locations of the users indicated by the positional information and the road, determining a passage roadside portion that is a roadside portion in which the locations of the users are distributed for each piece of the positional information;
a positional information summarizing step of counting a number of pieces of the positional information for which the passage roadside portion has been determined at the positional information distribution determination step for each of the roadside portions and summarizing a roadside portion traffic amount that is an amount of user traffic on each of the roadside portions;
a processing result output step of outputting the roadside portion traffic amount summarized at the positional information summarizing step, the road information including information regarding location of the road; and
a map matching processing step of, based on the information regarding the location of the road included in the road information, performing a map matching process on the positional information acquired at the positional information acquisition step and extracting the positional information that is associated with a road the roadside portion traffic amount of which is to be summarized, wherein
at the positional information distribution determination step, the passage roadside portion of the positional information extracted at the map matching processing step is determined.
